(19) United States
(12) Patent Application Publication
(10) Pub. No.: US 2009/0163140 A1
(43) Pub. Date: Jun. 25, 2009

(54) Biochip electroporator and its use in multi-site, single-cell electroporation

(76) Inventors: Donald L. Packham, Ft. Lauderdale, FL (US); Jay N. Cullimore, Okaland, MI (US); David Somner, Hollywood, FL (US); David Schmidtd, Jupiter, FL (US)

Correspondence Address: LORUSSO & ASSOCIATES, PO BOX 21915, PORTSMOUTH, NH, 03801, US

(21) Appl. No.: 11/883,476

(22) PCT Filed: Jan. 25, 2006
(86) PCT No.: PCT/US06/02814

§ 371 Date: Jul. 25, 2007

Related U.S. Application Data
(60) Provisional application No. 60/648,049, filed on Jan. 25, 2005.

(51) Int. Cl. H04B 7/00; H04M 1/00

(52) U.S. Cl. 455/41.2; 455/557

(57) ABSTRACT

A remote access and control system for remotely controlling a wide variety of devices using an application installed in a cell phone in conjunction with a control module in communication with the cell phone and the device(s). A portal-based access and control system is also disclosed.

### BACKGROUND OF THE INVENTION

1. Field of the Invention

The invention relates generally to systems and methods for remotely controlling a variety of devices via computers, PDA's, cellular hardware and the like using wireless communication technology. More particularly, the invention relates to systems and methods to block specific features provided with cellular phones such as video and/or picture feeds to and from the devices, to access live video feeds from remote locations and to remotely control a variety of household and automotive electrical devices and subsystems.

2. Statement of the Prior Art

Electronic devices are being continually developed and are becoming ever more sophisticated to meet a variety of needs of everyday life. Many of the devices are designed for remote operation. Infrared technology, for example, has been used extensively to act as the means to remotely control devices such as televisions and VCR's. With each new electronic appliance, a new remote control is introduced to the user. An added limitation is the need for a direct line for the infrared signal to travel. Infrared signals do not penetrate furniture or clothing so a direct line is needed between the infrared transmitter and the infrared receiver. What is needed is a device that can be used to control all the sophisticated functions of a wide variety of electronic devices from a single programmable source without the need for a direct line of sight in order for the device to successfully send a signal command. With the advent of Bluetooth-enabled 3G cell phones, it is now possible to download software into the cell phones that can be used for a virtually infinite variety of uses. By downloading software into the cell phone, one can now use the cell phone to remotely control a wide variety of devices with a single phone.

A yet further use of Bluetooth-enabled 3G cell phones is the remote operation of video systems so as to receive streaming video feeds from locations remote to the cell phone. With such a system, one can monitor, for example, a child enrolled in a daycare program. One in particular is the use of the phones for

### SUMMARY OF THE INVENTION

The system comprises hardware and software that allows Bluetooth® enabled cell phones or other wireless devices to operate numerous electronic devices and products that currently use remote controls. This is a vast universe of products from remotely controlled car systems to home electronics and commercial and industrial devices.

The hardware component of the system functions as the connection between the wireless device and the product to be operated. The component may be a small injection molded box with an output connector that allows different modules to be installed depending on the application. The distance required between the component and the wireless device is a function of the capabilities of the wireless device.

The main features of the component comprise two sections, a front-end and the output section. The front end section consists of a Bluetooth receiver and micro controller. The output section will perform different functions depending on the application. These functions include wireless transmitter, USB interface, serial interface, X-10 interface and TTL level and relay contacts for discrete device controlling. The system has the design flexibility to work with a full range of remote controlled devices by simply customizing the output sections.

One application is a keyless entry system for an automobile. This application enables a driver to unlock the car door or trunk with a Bluetooth enabled 3G or 54G Cell phone. Using a simple user-friendly screen, the car door can be opened from distances typical of traditional remote control instruments. The ability to use the cell phone as the mode for opening the car is in keeping with the trend of reliance upon cell phones and PDA's as an indispensable tool of 21^{st} century life.

By using a code programmed into the cell phone, an unlimited number of codes can be generated by the system so that no two codes are alike thereby limiting exposure to potential theft. In contrast, there are currently only approximately 16 different conventional key configurations used by the automobile industry. Thus, every 16^{th} car sold in the U.S. with a conventional key system has the identical key configuration.

Another application involves an automobile accident alert system. When an accident occurs, the system is designed to activate the cell phone and make an outbound call to an emergency number(s) when the air bag is deployed. The system controller will store profile information supplied by the user, such as name, age, sex, address, vehicle description, tag number usual vehicle occupants (children names and ages), any medication or medical emergency data. The system will operate using the 3G (or new 54G) cell phone GPS option and the system software will initiate an outbound cell phone call to a pre-defined emergency call center.

Another application is when an individual locks the keys in the car or trunk. The user simply calls his or her cell phone from another phone and enters a security code and unlock option. The system will issue the code to unlock the vehicle.

In another aspect, the system can inform a car dealer that an automobile including the system is on the premises. The car dealer will have local area software installed that will be able to receive specific information about the vehicle as it enters within the receiver's range. When the car is parked by the service department, the dealership in-house computer system will have received via wireless communications specific data and information. This information can be displayed on the service writer station screen or initiate the printing of a service ticket. The customer's service needs will be expedited, and the service writer productivity will increase. If the car is parked near the sales showroom, the sales department or sales manager will be notified of the presence of the vehicle and receive predetermined sales information.

The system can also be used to provide automobile security, automobile accident reporting, automotive dealer inventory management and security system activation.

The system is designed for single key control or operation. After the system software is programmed into the 3G class cell phone, the user can operate any key-fob function on the vehicle. The software employs Bluetooth communications protocol and allows the user to talk on the cell phone still be able to operate the key-fob functions. No charges have to be incurred if the cell phone functions with Bluetooth communications.

A yet further application is the use of an aftermarket remote starter. The car owner can remotely start the car's engine using the system supported cell phone and the Bluetooth communication protocol while maintaining all the security functions supplied with the aftermarket equipment.

Other applications include home security systems, electronic front door locks or X-10 devices. The user can operate other devices that have been programmed with the appropriate system security identification codes. The embodiments herein are illustrative and do not limit the scope of the invention.

A still further application is an auto-unlock feature. The cell phone can be programmed to send an unlock signal without the use of pressing any icon or button by selecting an “auto unlock” icon on the cell phone screen. As the user approaches the vehicle, the cell phone “recognizes” the vehicle and unlocks it.

The system can be programmed with macros to allow single key command(s) inputted into the 3G cell phone as a single key stroke. This is beneficial when the user wants multiple functions to occur simultaneously or on a regular basis.

In another aspect of the invention, an application provides a means to send and/or retrieve video signals. In a further aspect, an application provides a means to block video capability of a video-enabled cell phone by accessing an application residing in a website. These and other aspects of the invention will become apparent from a review of the drawings and a reading of the following detailed description of the invention.

It is to be understood that the embodiments shown and described herein are for illustrative purpose only and should not be considered as limiting the various potential embodiments for the remote control system. Numerous variations may be made of the cooperating parts all within the contemplation and spirit of the invention.

### BRIEF DESCRIPTION OF THE DRAWINGS

FIG. 1 is a system flow chart for installing and customizing the wireless communication system into a cell phone and automobile.

FIG. 2 is a system flow chart for operating and using the wireless communication system with a cell phone and an automobile.

FIG. 3 is a system flow chart for operating door locks in an automobile using the wireless cell phone enabled communication system.

FIG. 4 is a system flow chart for remotely unlocking automobile lock systems using the cell phone enabled wireless communication system.

FIG. 5 is a system flow chart for remotely and passively unlocking automobile lock systems using the cell phone enabled wireless communication system.

FIG. 6 is a system flow chart for remotely starting an automobile engine using the cell phone enabled wireless communication system.

FIG. 7 is a system flow chart for remotely operating automobile windows using the cell phone enabled wireless communication system.

FIG. 8 is a system flow chart for remotely operating a heads up display (H.U.D.) using the cell phone enabled wireless communication system.

FIG. 9 is a system flow chart for remotely viewing automobile engine sensors using the cell phone enabled wireless communication system.

FIG. 10 is a system flow chart for remotely operating an automobile trunk using the cell phone enabled wireless communication system.

FIG. 11 is a system flow chart for remotely operating an automobile gas cap with a cell phone enabled wireless communication system.

FIG. 12 is a system flow chart for remotely operating an automobile hood with a cell phone enabled wireless communication system.

FIG. 13 is a system flow chart for remotely operating an automobile alarm system with the cell phone enabled wireless communication system.

FIG. 14 is a system flow chart for remotely operating a garage/hangar door with the cell phone enabled wireless communication system.

FIG. 15 is a system flow chart for transferring data with respect to automobiles using the cell phone enabled wireless communication system.

FIG. 16 is a system flow chart for an automobile emergency assistance system using the cell phone enabled wireless communication system.

FIG. 17 is a system flow chart for remotely controlling an automobile climate control system using the cell phone enabled wireless communication system.

FIG. 18 is a system flow chart for an automobile dealer inventory management system using the wireless communication system.

FIG. 19 is a system flow chart for remotely controlling an automobile security system loudspeaker using the cell phone enabled wireless communication system.

FIG. 20 is a system flow chart for remotely controlling an automobile video security system using the cell phone enabled wireless communication system.

FIG. 21 is a system flow chart for remotely controlling an automobile anti-theft system using the cell phone enabled wireless communication system.

FIG. 22 is a system flow chart for remotely controlling an automobile entertainment system using the cell phone enabled wireless communication system.

FIG. 23 is a system flow chart for installing and customizing the wireless communication system to retrieve video transmissions into a cell phone.

FIG. 24 is a system flow chart for operating and using the wireless communication system with a cell phone and an automobile.

FIG. 25 is a system flow chart for remotely viewing child care facilities with the cell phone enabled wireless communication system.

FIG. 26 is a system flow chart for remotely operating household appliances and automobile systems with the cell phone enabled wireless communication system.

FIG. 27 is a system flow chart for remotely blocking cell phone functions with the wireless communication system.

FIG. 28 is a system flow chart for configuring a remotely operated cell phone function control system using the cell phone enabled wireless communication system.

FIG. 29 is a system flow chart for operating a remotely controlled cell phone function control system using the cell phone enabled wireless communication system.

FIG. 30 is a system flow chart for installing a remotely controlled cell phone function control system using the cell phone enabled wireless communication system.

FIG. 31 is a system flow chart for activating a remotely controlled cell phone function control system using the cell phone enabled wireless communication system.

FIG. 32 is a system flow chart for deactivating a remotely controlled cell phone function control system using the cell phone enabled wireless communication system.

FIG. 33 is a system flow chart for removing software with respect to a remotely controlled cell phone function control system using the cell phone enabled wireless communication system.

FIG. 34A-B is a cell phone installed application system flow chart in accordance with one embodiment of the invention.

FIG. 35 is a block diagram of a command execution according to one embodiment of the invention.

FIG. 36 is a passive unlock auto distance block diagram according to one embodiment of the invention.

FIG. 37 is a view engine monitoring sensor block diagram according to one embodiment of the invention.

FIG. 38 is a home electronics gate operator block diagram according to one embodiment of the invention.

FIG. 39 is a Repair Shop/Dealer Vehicle Data Exchange block diagram according to one embodiment of the invention.

FIG. 40 is a personal location system block diagram according to one embodiment of the invention.

FIG. 41 is a general system layout flow chart according to one embodiment of the invention.

FIG. 42 is an application installation and billing flow chart according to one embodiment of the invention.

FIG. 43 is a circuit diagram for an automobile-based control module according to one embodiment of the invention.

FIG. 44 is a circuit diagram for a home-based control module according to another embodiment of the invention.

FIG. 45 is a universal transmitter circuit diagram according to one embodiment of the invention.

FIG. 46 is a application opener installation according to one embodiment of the invention.

### DETAILED DESCRIPTION

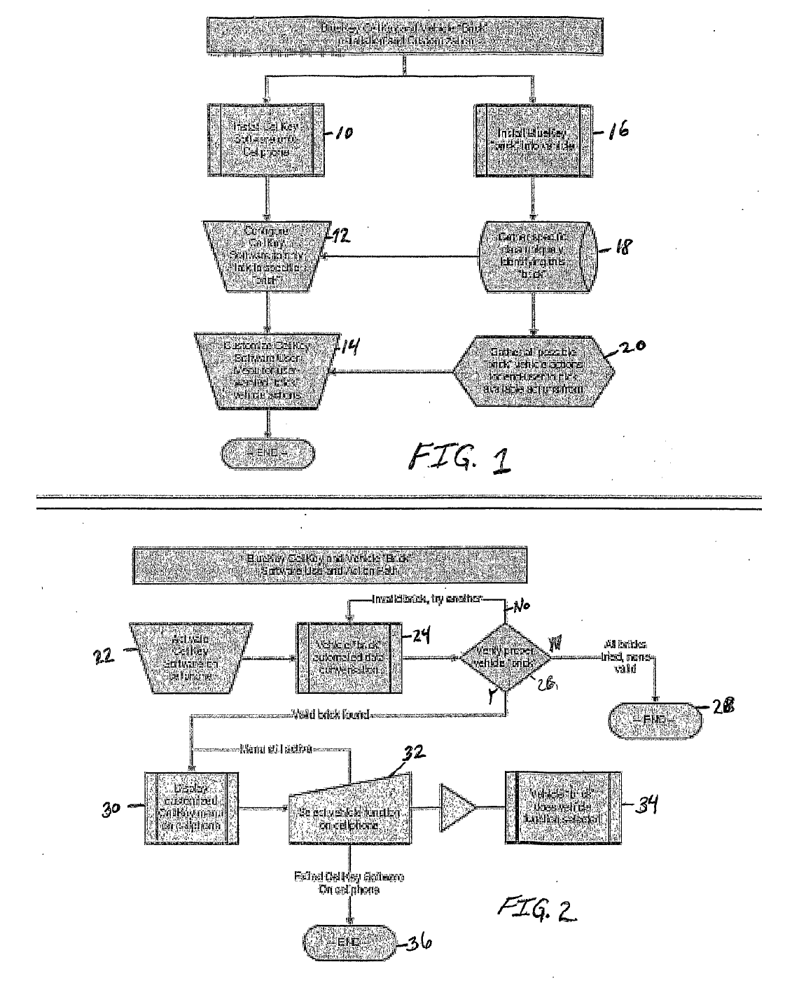

In one aspect of the invention, a 3G cell phone is used to remotely control a variety of functions in an automobile. As depicted in FIG. 1, application software 10 is installed in the cell phone to communicate to a “black box” or “control module” as used in FIG. 1 to control the various functions. The control module includes a front end wherein a Bluetooth™ receiver and micro controller are installed to receive and process wireless signals received from the cell phone. The control module also has a back end with an output connector situated to receive different modules to control different functions in the automobile. The output section can perform a number of functions, including but not limited to, wireless transmitter, USB interface, serial interface, X-10 interface, and TTL level and relay contacts for discrete device controlling. By customizing the output section, a full range of devices can be remotely controlled.

Referring again to FIG. 1, in step 10, application software is installed into a cell phone to control a control module installed in an automobile in step 16. In step 18, the cell phone retrieves unique identifying information from the control module. In step 12, the software is configured using the unique identifying information to communicate with a single control module or to a discrete number of control modules having the same identifying information. In step 20, the cell phone retrieves information regarding the functions controlled by the control module. In step 14, the software user menu is customized for the desired and available automobile functions.

Referring now to FIG. 2, a block diagram showing the software use and action path is depicted. In step 22, the software is activated by selecting either activation button keys or activation selections on a touch screen menu depending on the particular cell phone configuration. In step 24, the vehicle control module or “brick” undergoes an automated data conversation with the cell phone to verify in step 26 whether the proper vehicle “brick” has been selected. If no, the verification step is repeated until either a valid brick is found or until all bricks have been tried. If none prove to be valid, the system goes to end step 28. If a valid brick is located, a customized menu is displayed in the cell phone in step 30. The user then selects the desired vehicle function on the cell phone menu in step 32. The “brick” then activates the selected function in step 34. Once the desired functions have been activated, the user selects the exit option on the menu to reach end step 36.

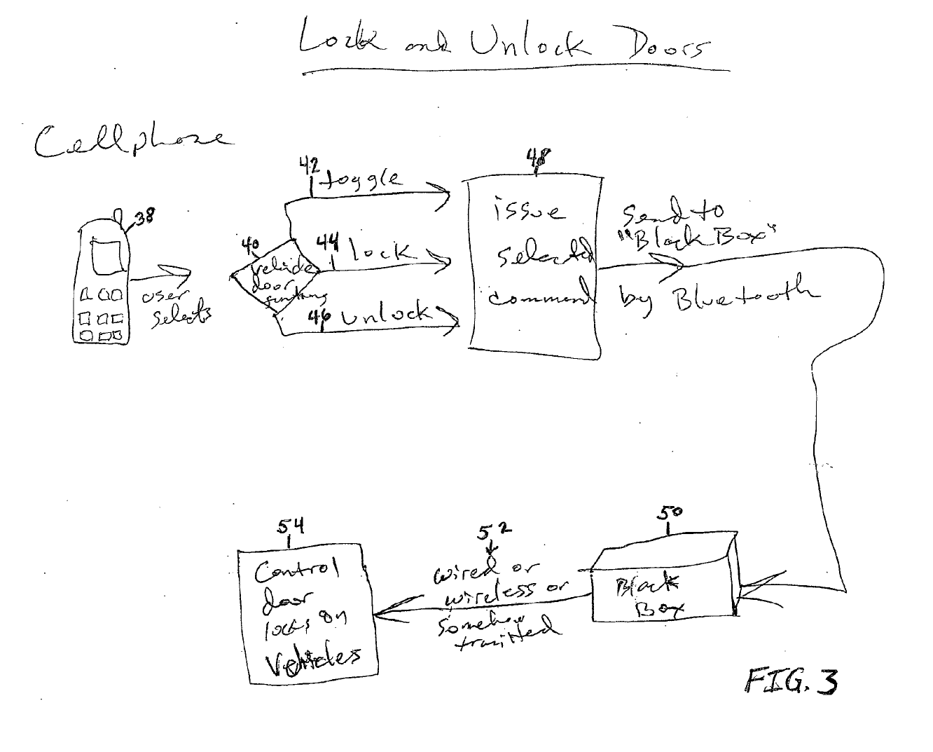

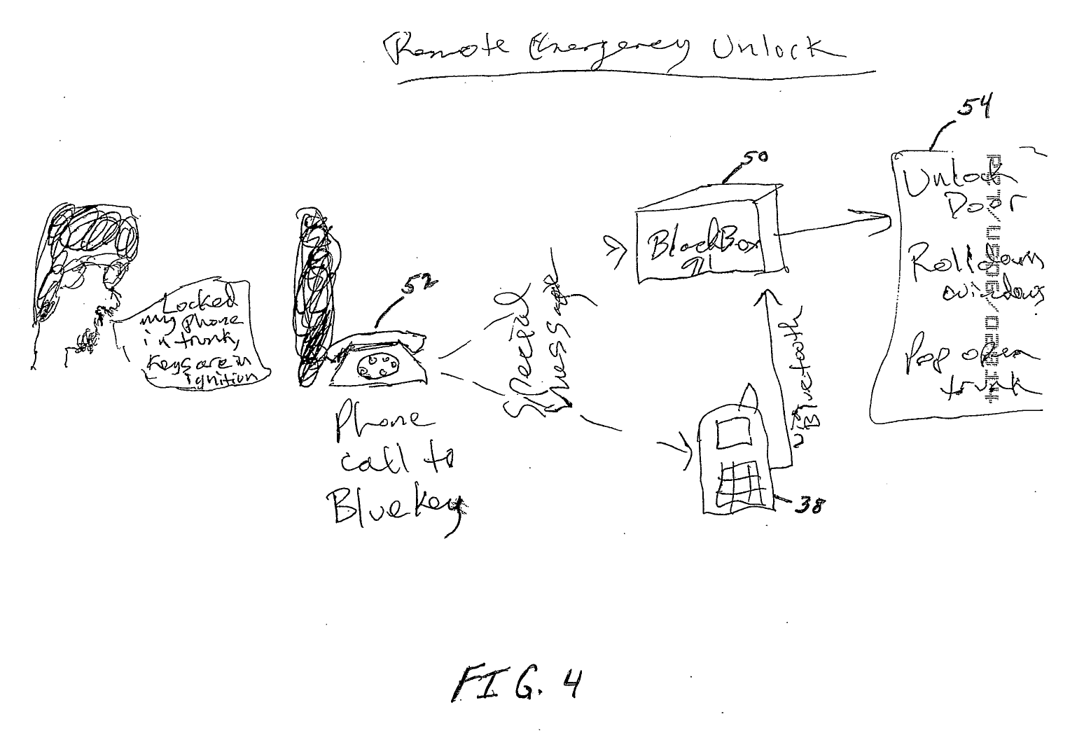

FIGS. 3-22 are illustrative of a non-exhaustive and non-limiting list of vehicle functions that can be controlled using the “control module” system.

FIG. 3 is a block diagram for remotely operating door locks. Using cell phone 38, the user selects the vehicle door function on the cell phone menu, step 40 and selects between three options on the next screen menu, toggle 42, lock 44 or unlock 46. By selecting the desired function and issue selected command 48 is initiated, which is sent to the control module 50 wherein the selected function is sent via hard wire, wirelessly or by other means to the vehicle door locks 54, which are operated in accordance with the delivered command.

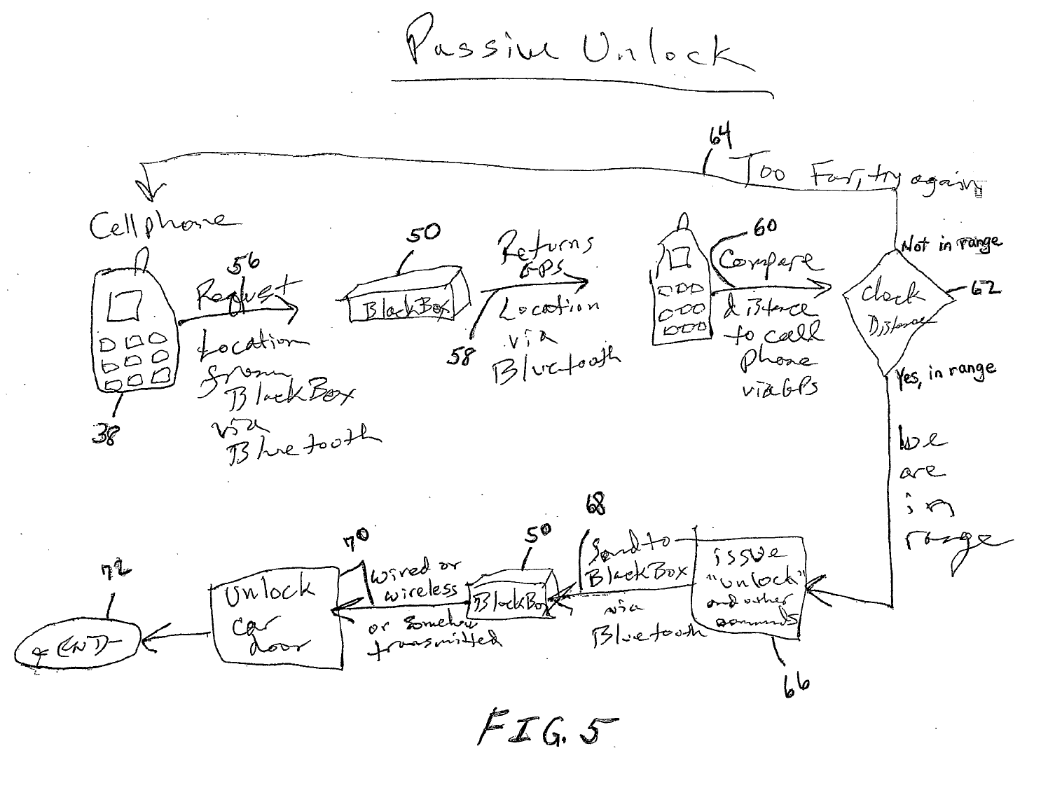

As illustrated in FIG. 4, the system also provides a means to remotely operate the cell phone 38 in an emergency such as when the phone is inadvertently locked in a vehicle along with the vehicle keys. The application user uses a second phone, wired or wireless, to place a call into a server that relays a message via cell phone 38 to control module 50 using Bluetooth or other transmission media. Control module 50 then operates one or more features of the automobile, e.g. door lock, window and/or trunk to enable the user to gain access to the car and/or car keys.

Referring to FIG. 5, the system provides a means to passively unlock an automobile door. The process begins by selecting a request to identify position on a screen or other menu on cell phone 38 that is sent to control module 50 via Bluetooth or other transmission media. Control module 50 retrieves GPS information internally or from a GPS device in communication with control module 50 and sends the information to cell phone 38. The application in cell phone 38 determines if the phone is in range to deliver an unlock command. If not in range, the user is prompted about the situation. If in range, the unlock command is sent from cell phone 38 to control module 50 via Bluetooth or other transmission media. The command is then transmitted to the door lock via wired or wireless transmission. Upon successful unlocking, the process reaches end step 72. In one embodiment, an unlock verification signal can be sent back through control module 50 to cell phone 38 where the signal can be brought to the attention of the user via visual or audio means.

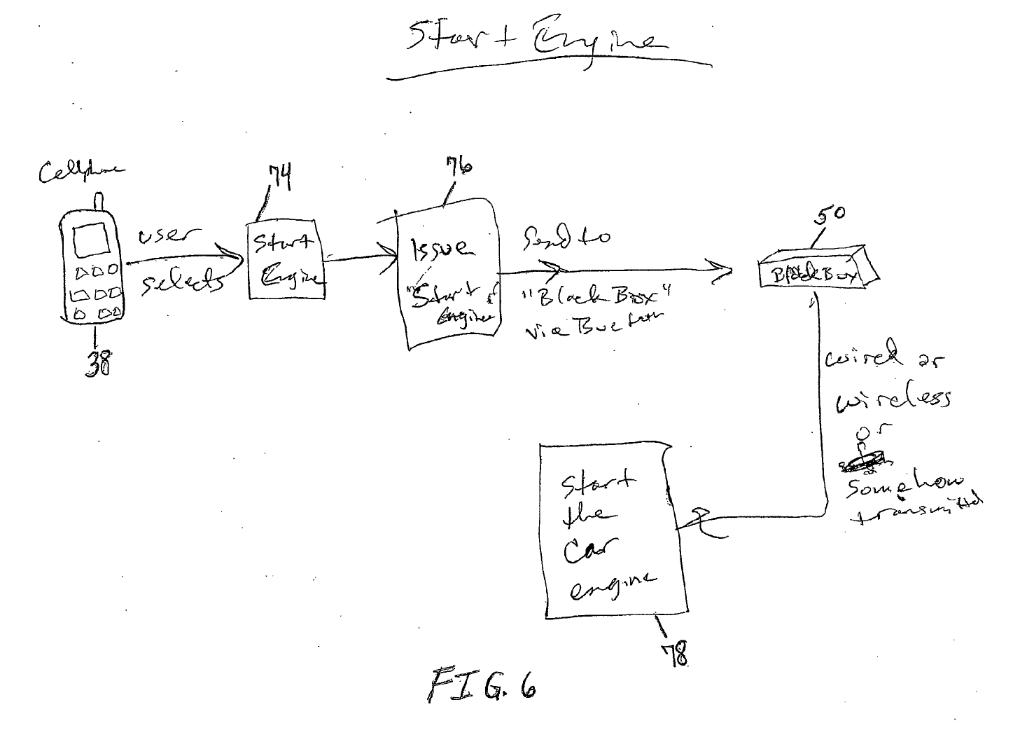

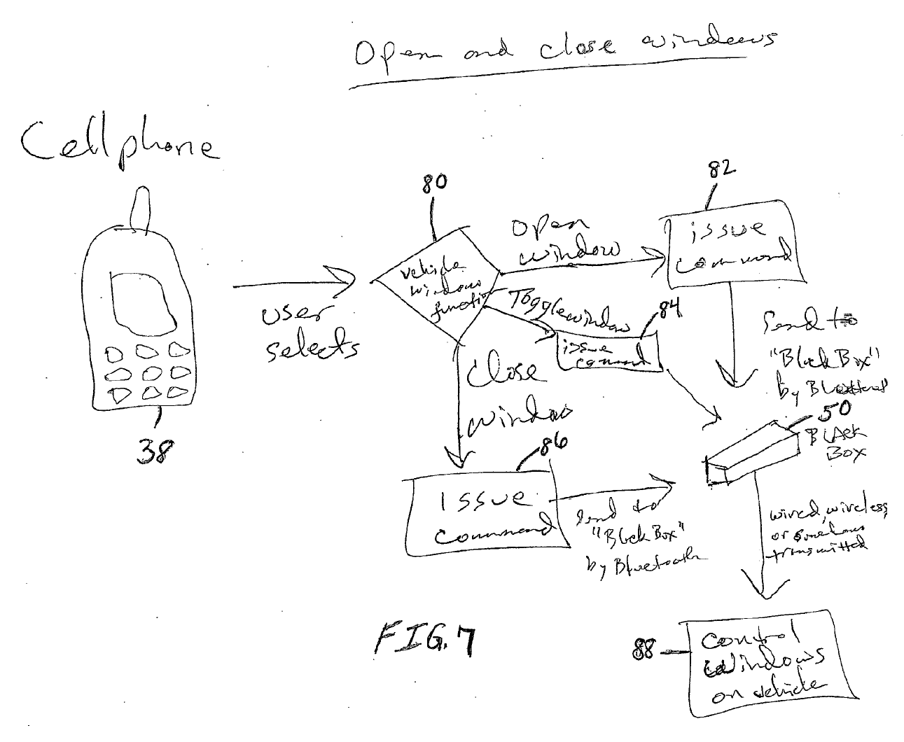

Referring to FIG. 6, a start engine process is shown. This process begins with a user selecting a start engine command and having the command sent from cell phone 38 to control module 50 via Bluetooth or other transmission media. The command is then relayed by control module 50 to the engine via wired or wireless transmission at step 78. Optionally, an engine start verification signal can be transmitted back to cell phone 38 via control module 50.

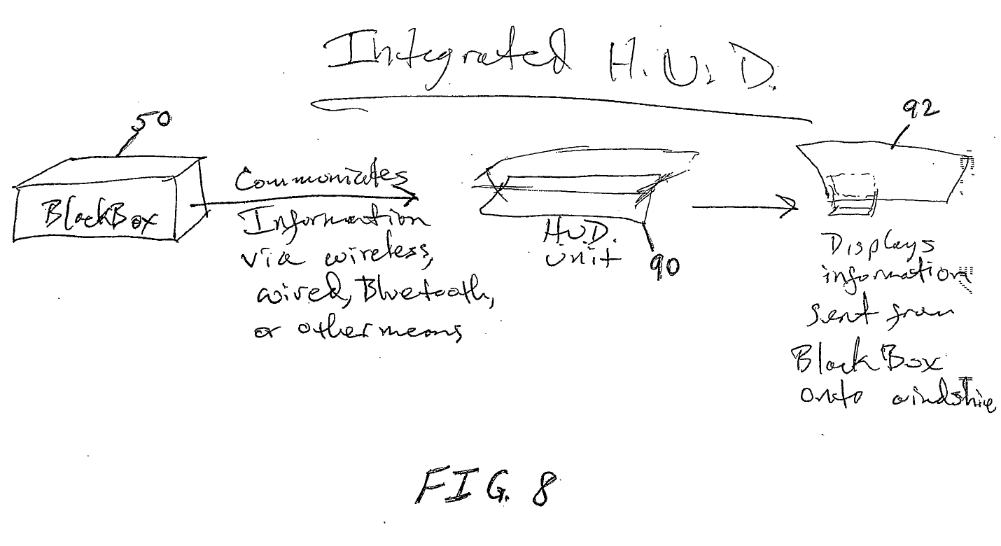

Referring to FIG. 7, a window operating process is shown. A window operating function, e.g. open window, toggle window and/or close window, is selected on cell phone 38 and an issue command, 82, 84, and/or 86 is sent to control module 50 via Bluetooth or other transmission media. The selected command is then transmitted to one or more windows via wired or wireless transmission at step 88. Optionally, a window status signal can be relayed back to cell phone 38 via control module 50.

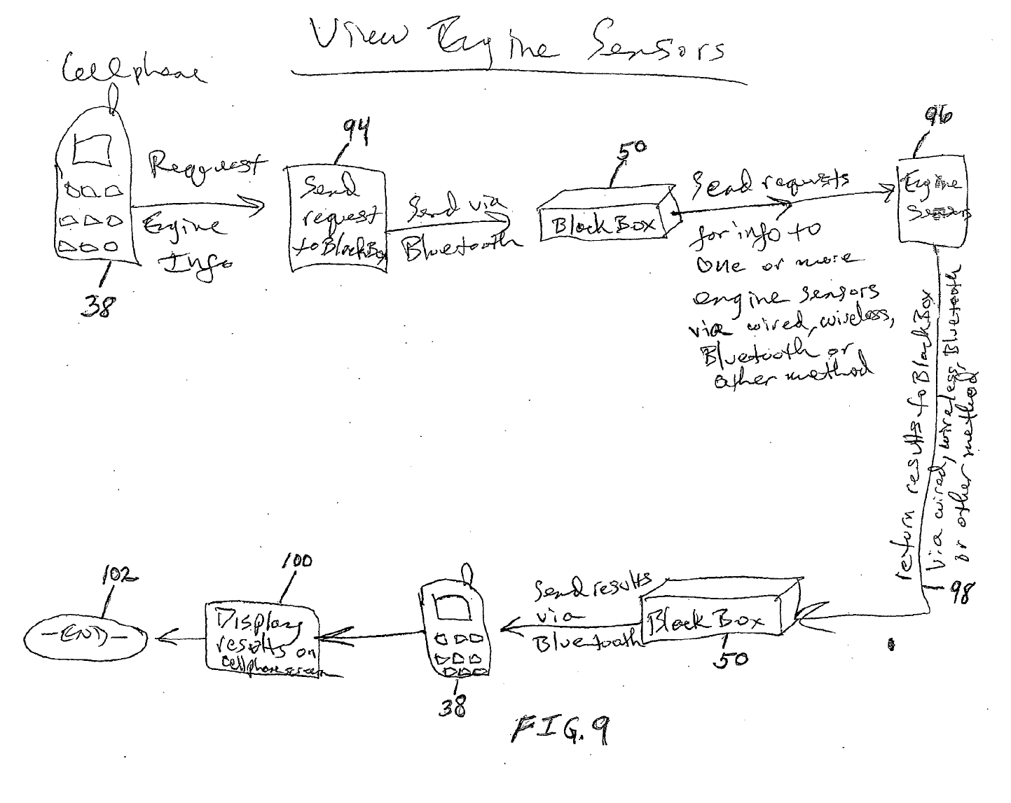

FIG. 8 shows an integrated heads-up display (H.U.D.) process. To initiate a heads-up display, a user sends a command or communicates information to control module 50 connected to a HUD unit 90. The information is then displayed on automobile windshield at step 92. The command and/or information can be sent to control module 50 via cell phone 38.

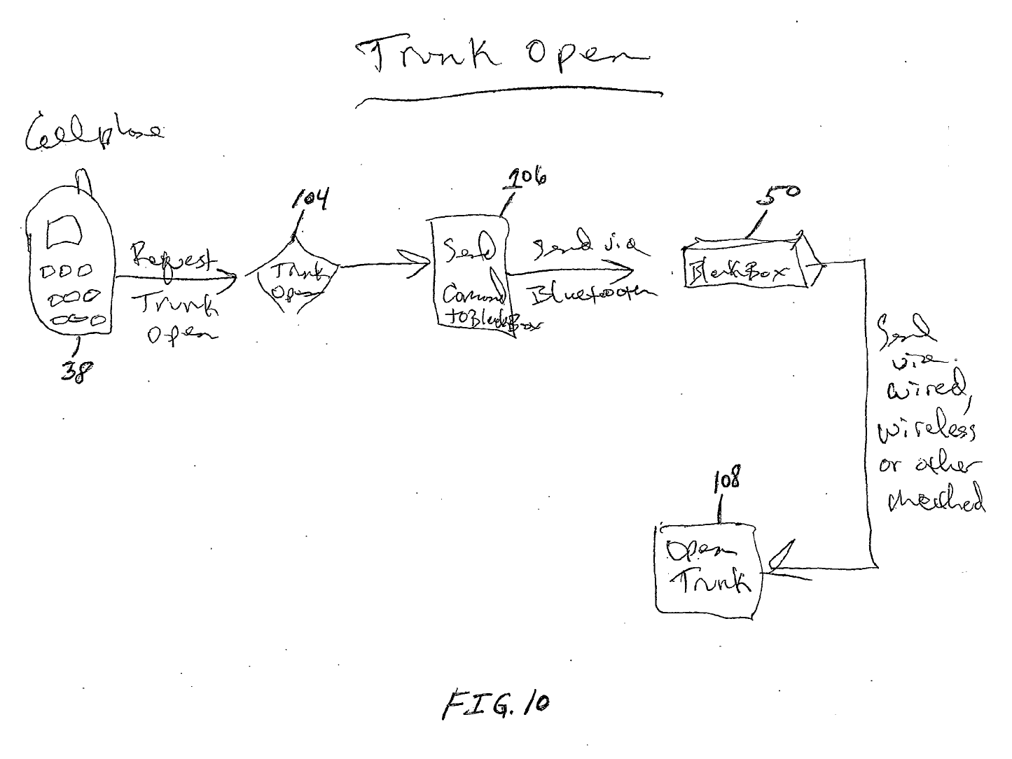

FIG. 9 shows a means to monitor a variety of engine functions. A user selects an engine information request command on cell phone 38, which is sent to control module 50 via Bluetooth or other transmission media at step 94. The request is relayed to engine sensors via Bluetooth, wired, wireless or other transmission method at step 96. Each activated sensor sends information back to control module 50 at step 98. The information is then relayed by control module 50 to cell phone 38 by Bluetooth or other transmission media. The information is displayed on cell phone 38 at step 100. If no further information requests are sent, the process ends at step 102.

FIG. 10 shows a remote controlled trunk operation process. A trunk open request is selected from cell phone 38 at step 104 and sent to control module 50 at step 106 via Bluetooth or other transmission media. Control module 50 sends a signal via wired or wireless means to a trunk lock so as to disengage the lock at step 108. Optionally, a trunk open confirmation signal can be sent back to cell phone 38 via control module 50.

Referring to FIG. 11, a gas cap operation process is shown. A user selects a gas cap open function from cell phone 38 at step 110. The command is sent to control module 50 at step 112. Black box 50 sends the signal via wireless or wired means to a gas cap lock at step 114. Optionally, a gas cap open signal can be relayed back to cell phone 38 via black box 114.

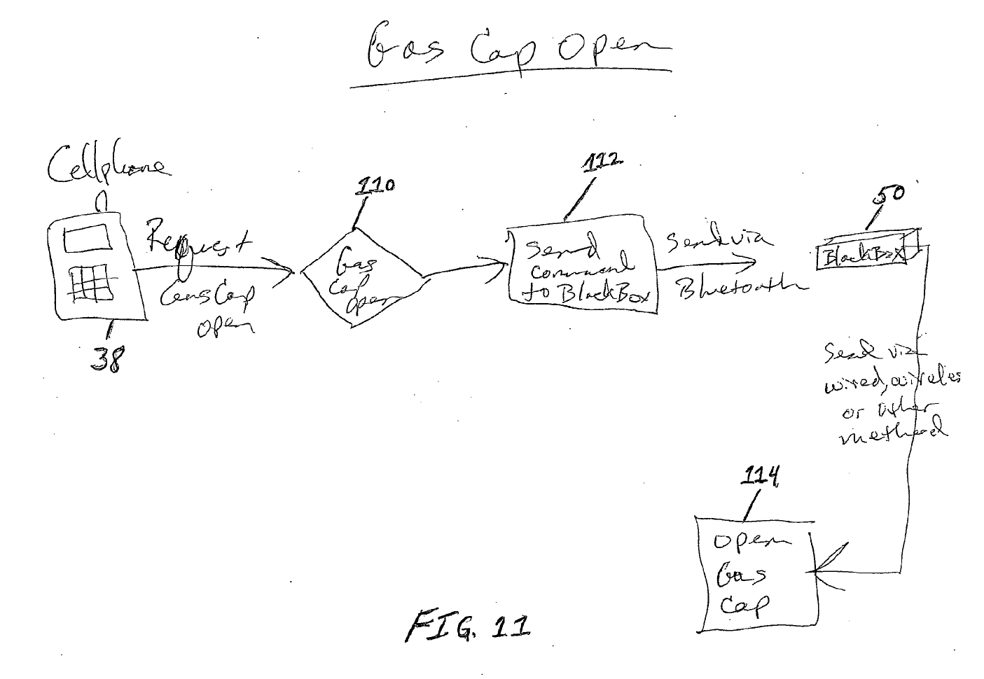

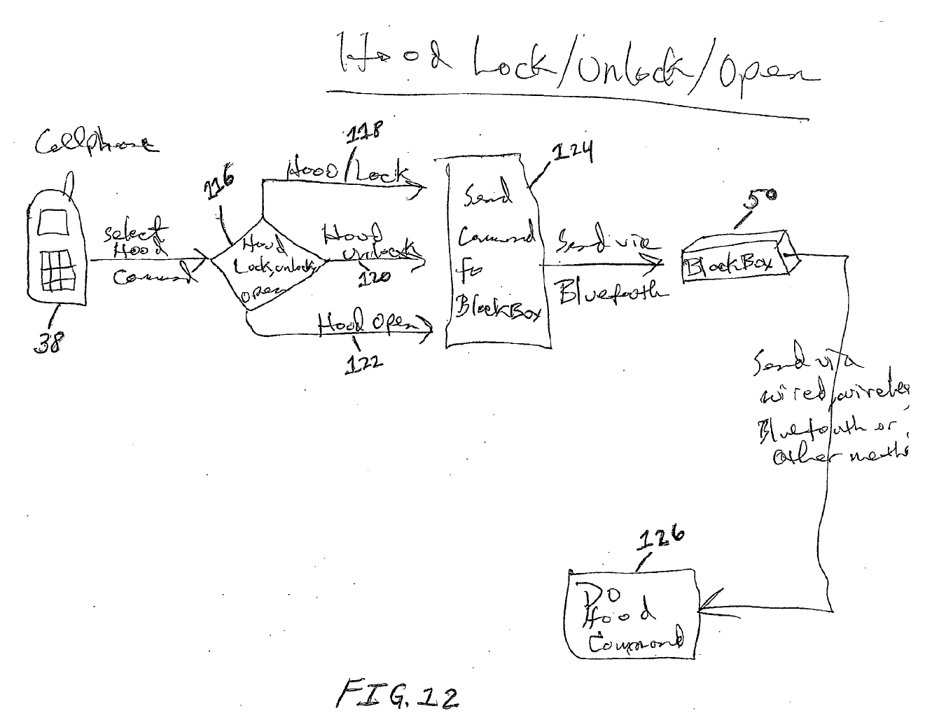

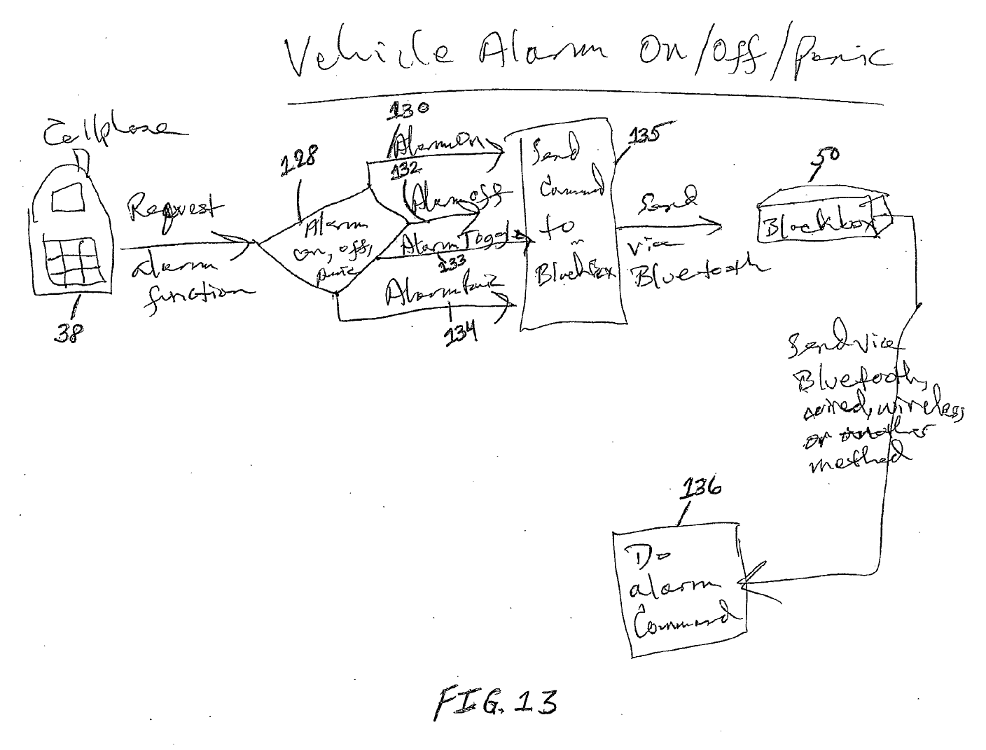

FIG. 12 shows a hood lock/unlock function. A user selects a hood operation command, e.g., hood lock 118, hood unlock 120 and/or hood open 122 command, at step 116. The selected command is sent to control module 50 at step 124. Control module 50 relays the selected command to a hood lock via wired or wireless means at step 126. Optionally, a hood status sensor can relay a status signal back to cell phone 38 via control module 50.

FIG. 13 shows an automobile alarm control process. A user selects an alarm request function, e.g., alarm on 130, alarm off 132, alarm toggle 133 and/or alarm panic 134 at step 128. The selected command is sent to control module 50 via Bluetooth or other transmission media at step 135. Control module 50 relays the command to an alarm via wired or wireless transmission at step 136. Optionally, an alarm status signal can be relayed back to cell phone 38 via control module 50.

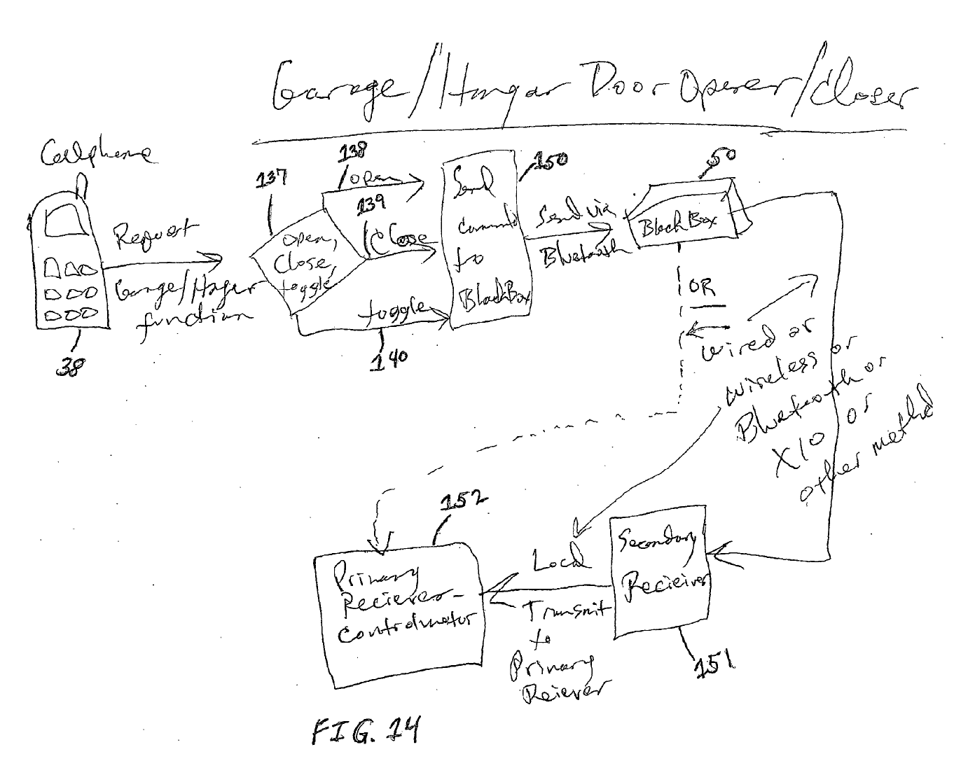

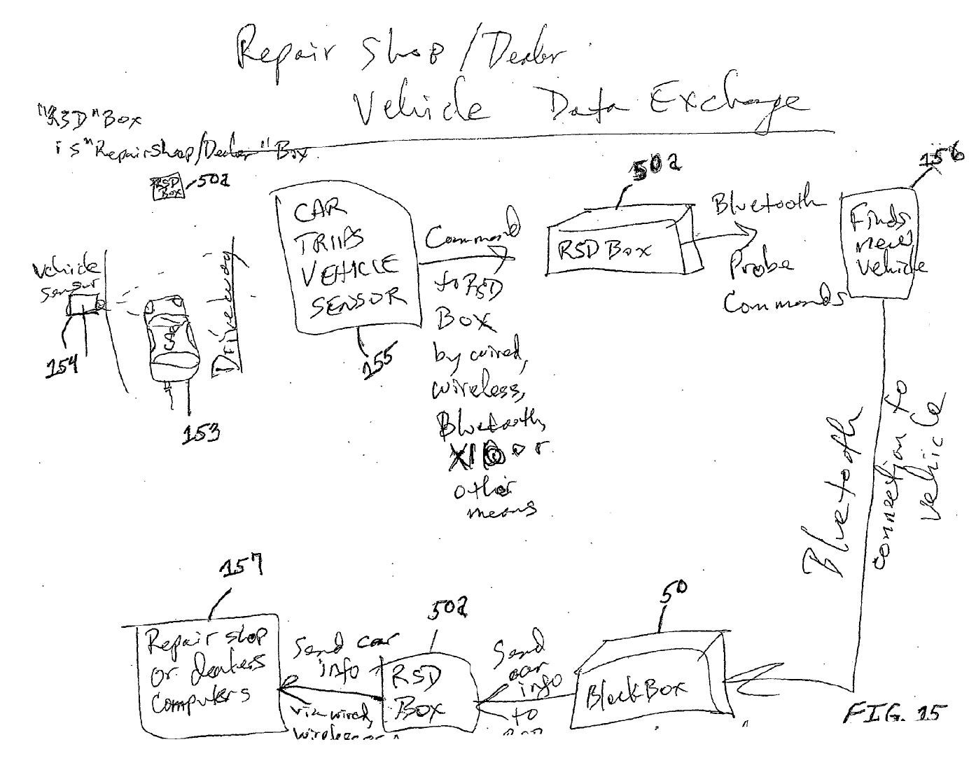

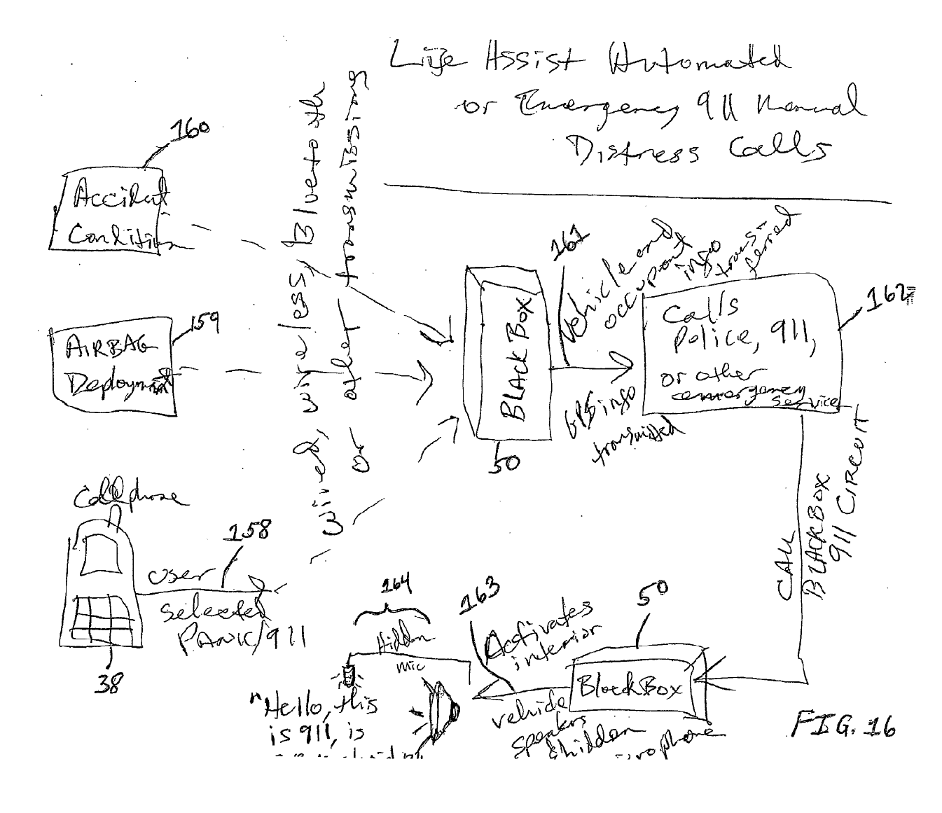

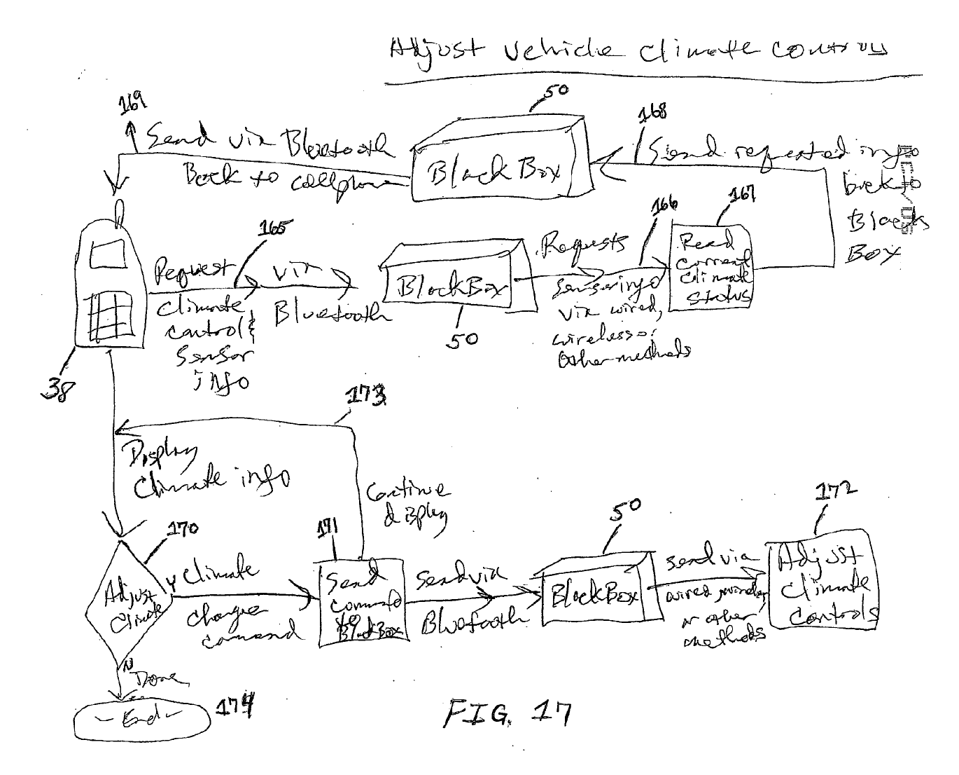

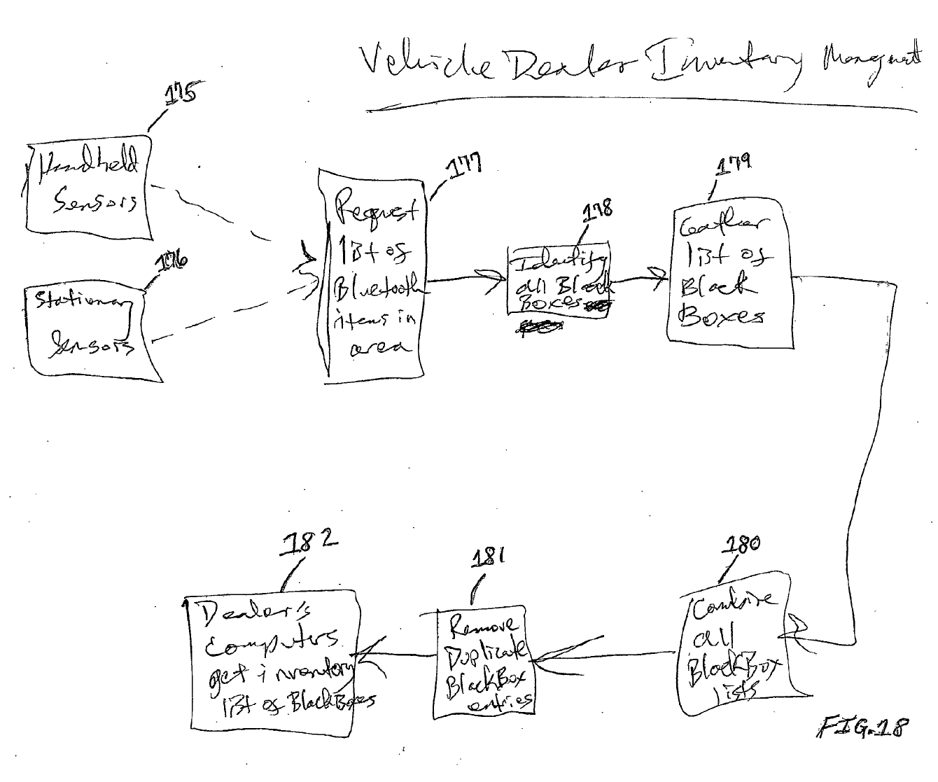

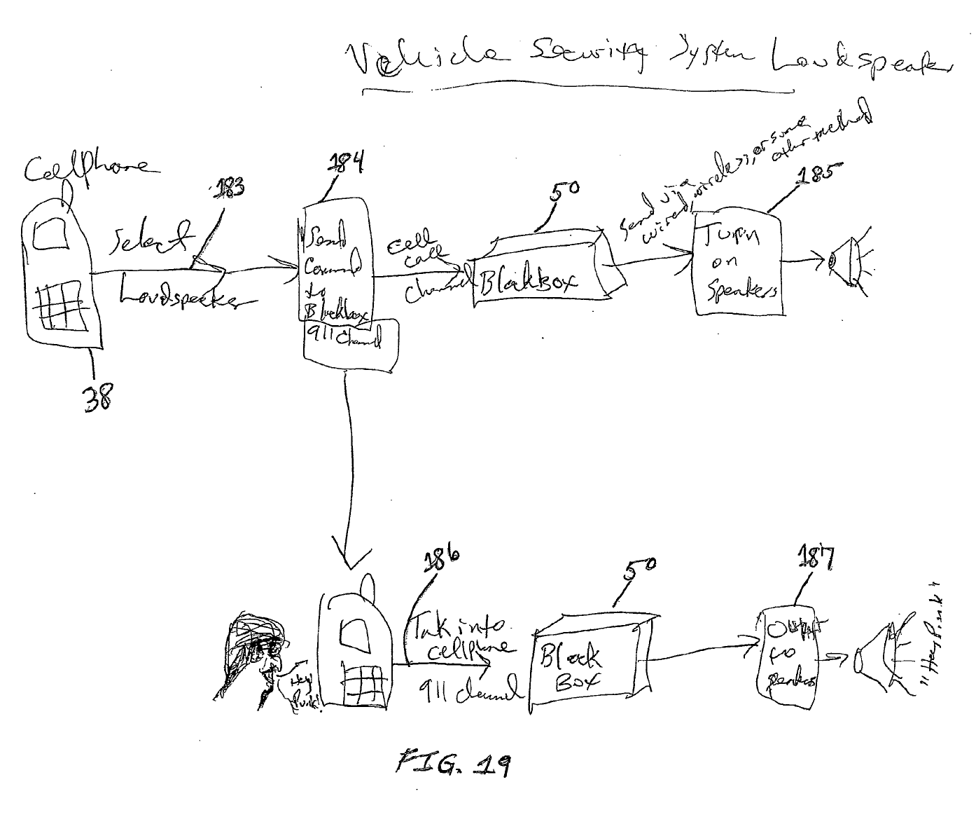

FIG. 14 shows a door operation function. A user selects a door operation function, e.g., open 138, close 139 and/or toggle 140 at step 137. The selected command is sent to control module 50 via Bluetooth or other transmission media at step 150. Control module 50 relays the command via one or two alternate routes. In a first route, the signal is relayed to a secondary received at step 151. The command is next sent to a primary receiver/motor controller at step 152. Alternatively, the selected command can be sent directly to the primary receiver from control module 50 via wired or wireless transmission. Optionally, a door status signal can be relayed back to cell phone 38 via control module 50 and any other intermediary device.

FIG. 15 shows a vehicle data exchange process between an automobile and a repair shop/dealer. A repair shop/dealer box (“RSD box”) 50a is situated in an automobile repair shop/dealer facility. Box 50a has essentially the same features as control module 50 so as to receive Bluetooth transmissions. Box 50a is connected to a vehicle sensor 154 via wired or wireless connection. Vehicle sensor 154 is designed to identify the presence of control module 50 in an automobile. The process begins by having a vehicle 153 coming into communication range with sensor 154 so as to “trip” the sensor at step 155. Sensor 154 sends a command to box 50a via wired or wireless communication such as Bluetooth, X10 or other means. Probe commands are emitted by box 50a to control module 50 at step 156. Control module 50 sends automobile information, e.g., diagnostic data, to box 50a. Received information is relayed to a computer or other display device in the repair shop/dealer for use by service technicians at step 157.

FIG. 16 shows processes for addressing emergency situations with the inventive device and application. When a vehicle has been in an accident, emergency information can be communicated to emergency response facilities and/or personnel via one of several means. To the extent the driver and/or passenger is capable, a panic or 911 distress signal can be sent from cell phone 38 via wired or wireless communication such as Bluetooth at step 158 to an emergency control module 50 situated to receive emergency signals. If enabled, cell phone 38 can be configured to send a distress signal automatically when a sudden and significant jarring motion is experienced by the cell phone.

In an alternative embodiment, an airbag deployment 159 can act as a trigger for a control module 50 situated in an automobile wrecked in an accident to send a distress signal to an emergency control module 50 situated in an emergency response facility. In a yet further embodiment, other accident condition triggers or sensors 160 situated within or without control module 50 can activate black box 50 to send a distress signal to an emergency control module 50. Emergency control module 50 then sends GPS position and vehicle occupancy information to an emergency response facility at step 162. Personnel or an automated system at the emergency response facility then transmits to control module 50 in the wrecked vehicle audio signals. Control module 50 then activates a vehicle speaker/microphone system 164 at step 163. The system enables any vehicle passenger to send back audible signals the emergency response facility.

FIG. 17 shows a remotely operated automobile climate control system. A user selects a climate control sensor information request at step 165 from cell phone 38. The request is sent to control module 50 via Bluetooth or other transmission media. The request is relayed to climate control sensors at step 166. The sensors obtain climate parameter status at step 167 and relay the information back to control module 50 at step 168. Control module 50 relays the information back to cell phone 38 at step 169. Optionally after or without the sensor data process, the user can select climate adjustment commands at step 170 that are sent to control module 50 at step 171 Bluetooth or other communication media. The commands are then relayed to climate control systems to adjust accordingly at step 172. The selected command can be looped back to cell phone 38 to prompt the user as to the selected command and/or continue displaying the selected command at step 173. When the user is satisfied with the settings and no further commands are sent, the process goes to an end at step 174.

Referring to FIG. 18, a vehicle dealer inventory management system is shown. Each vehicle is provided with a control module 50 with a unique electronic signature. Either handheld 175 or stationary 176 sensors are used to detect the presence of control module 50. A request for a list of Bluetooth enabled boxes in the transmission area is made at step 177. The information may be stored, for example, in a resident computer. Once the list is obtained, the sensors 175 and/or 176 identify all control module 50 in the transmission area at step 178. A list is compiled at step 179. The initial list and compiled list are compared at step 180. Duplicates are removed at step 181. Updated inventory information is relayed to resident computers at step 182.

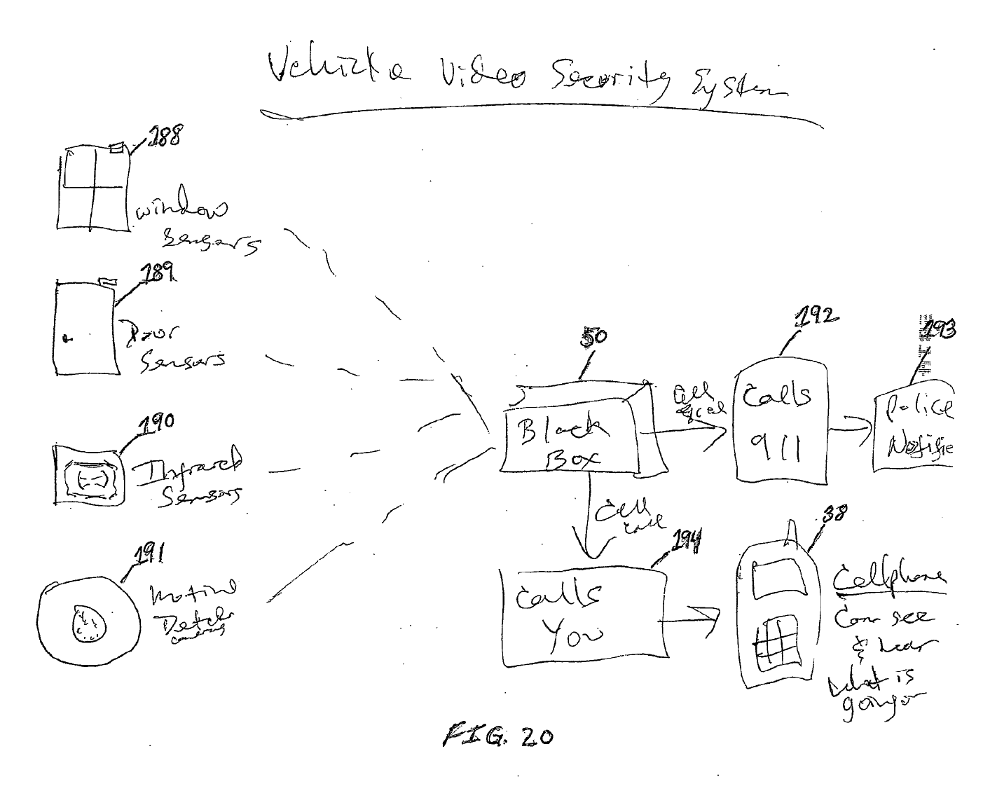

FIG. 19 shows a vehicle security system loudspeaker control process. A user selects a loudspeaker command from cell phone 38 at step 183. The command is sent to control module 50 at step 184. The command is relayed via wired or wireless communication to a loudspeaker at step 185. In an alternative embodiment, a loudspeaker on command can be sent as well as a distress 911 call over the loudspeaker by speaking into cell phone 38 at step 186. The audible signal is relayed to control module 50 on a 911 channel and then relayed as an output to speaker at step 187.

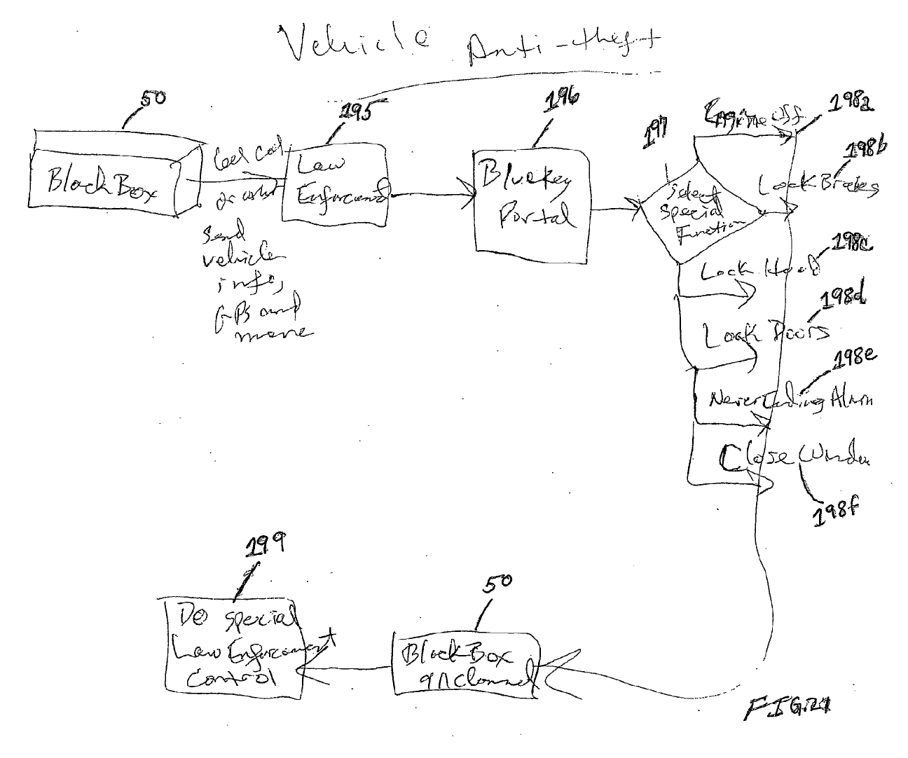

FIG. 20 shows a vehicle video security system. One of several triggers, window sensors 188, door sensors 189, infrared sensors 190 and/or motion detection sensors 191, send a signal to control module 50. Control module 50 sends a signal to a 911 call reception center at step 192 or alternatively sends a signal to one or more cell phones 38 at step 194. If the call reception center is used, a signal can be sent to an emergency response facility such as a police station at step 193.

FIG. 21 shows vehicle anti-theft system operated with a control module 50. Control module 50 sends information via Bluetooth or other transmission media to a police station at step 195. Information such as GPS data, vehicle information, and/or operator information may be sent. The police station then accesses a portal 196 to send a variety of commands, e.g., engine off 198a, lock brakes 198b, lock hood 198c, lock doors 198d, trigger alarm 198e and/or close window 198f may be implemented at step 197. The command is sent to control module 50 via Bluetooth or other communication media to enable law enforcement control of the vehicle at step 199.

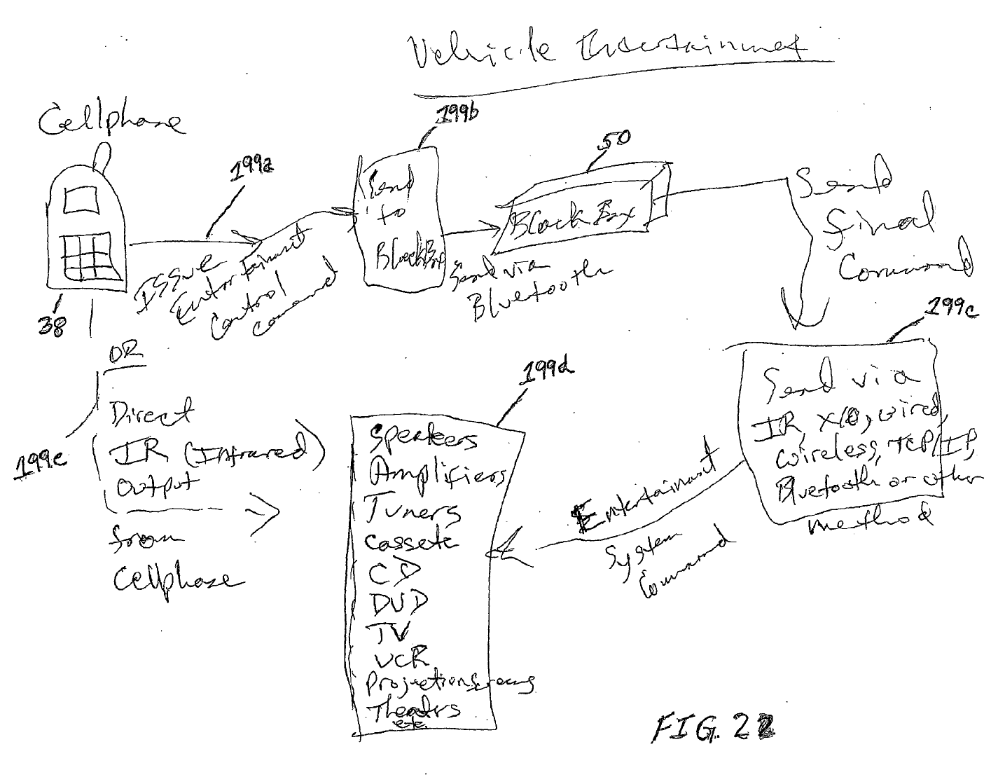

FIG. 22 shows a vehicle entertainment control process. A user selects an entertainment system control command from cell phone 38 at step 199a. The command is sent to control module 50 at step 199b via Bluetooth or other transmission media. Control module 50 relays the command via IR, X10, wired, wireless, TCP/IP, Bluetooth or other method to the entertainment system at step 199c. Components such as speakers, amplifiers, tuners, cassette player, CD, DVD, TV and/or VCR players, and/or projection screens can be controlled in this fashion.

FIG. 23 shows a remotely operated video transmission application installation and customization process. Control module 50 with video conversion capability is installed and can take video camera input and can provide TCP/IP video output at step 3. TCP/IP video pre-processing/compression software and hardware is installed at a facility having video cameras at step 5. Customer administration software and hardware is also installed at the same facility at step 7. A customized customer portal website is installed at step 9. Application software to remotely control video feeds from the facility is installed in cell phone 38 at step 11.

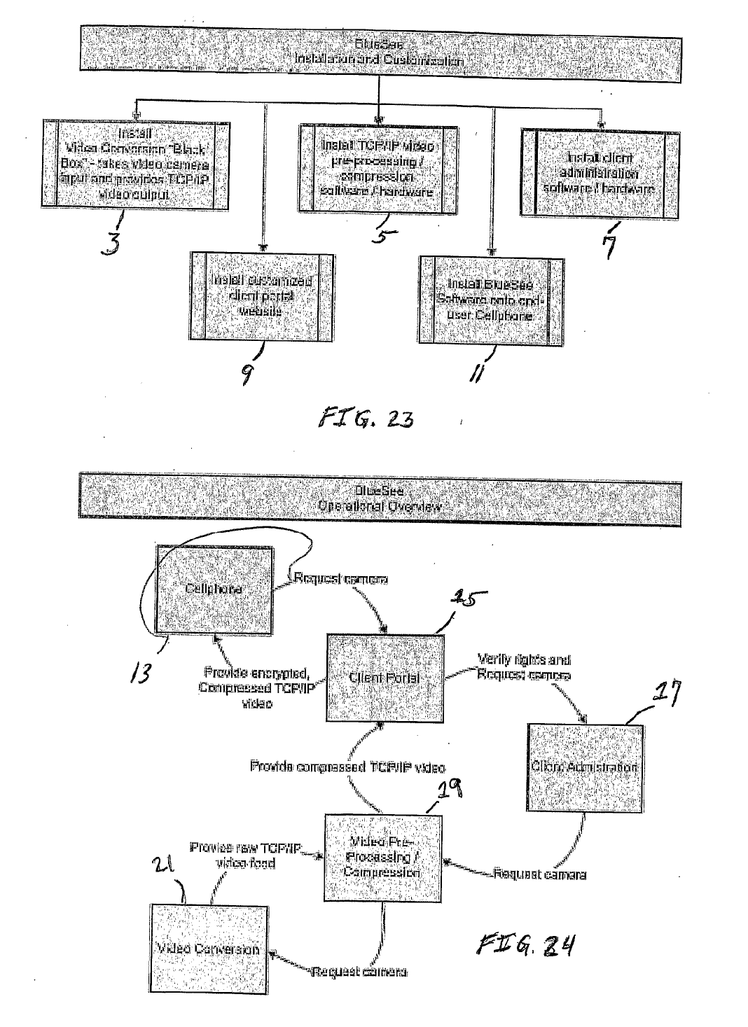

FIG. 24 shows an operation overview of a remotely controlled video transmission process. A user sends a video camera request to a customer portal 15 with cell phone 38 having video capability at step 13. Customer access verification is performed at the portal and the camera request is forwarded to customer administration at step 17. The camera request is relayed a video pre-processing/compression application at step 19. The camera request is then relayed for video conversion at step 21. Raw TCP/IP video feed is provided back for video pre-processing/compression to provide compressed TCP/IP video back to the portal. Encrypted compressed TCP/IP video is transmitted from the portal to cell phone 38 for viewing by the user.

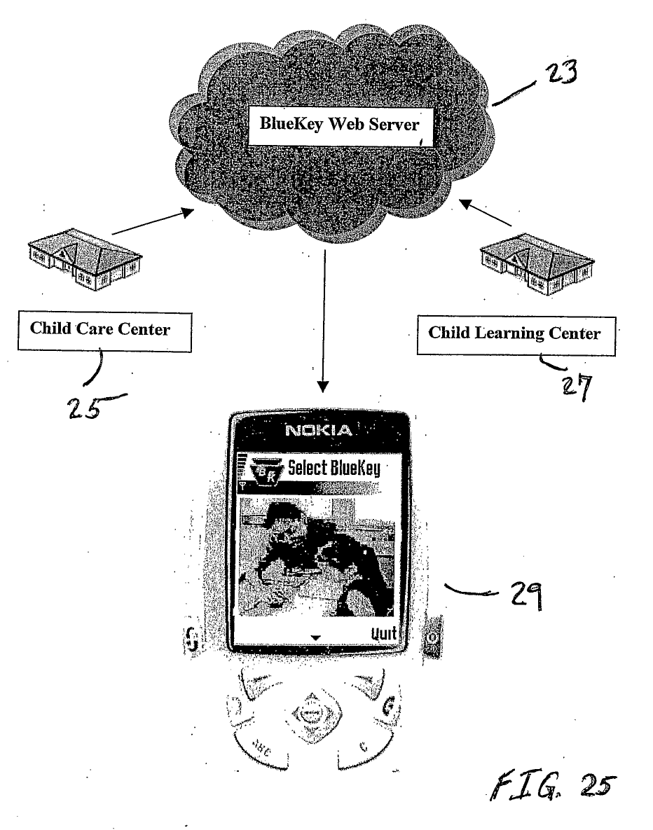

Referring to FIG. 25, a video display system host network is shown. Video cameras situated at various facilities such as child care centers 25 and child learning centers 27 feed video to a web-based server 23. The video is transmitted to cell phones 29 having the appropriate authorization.

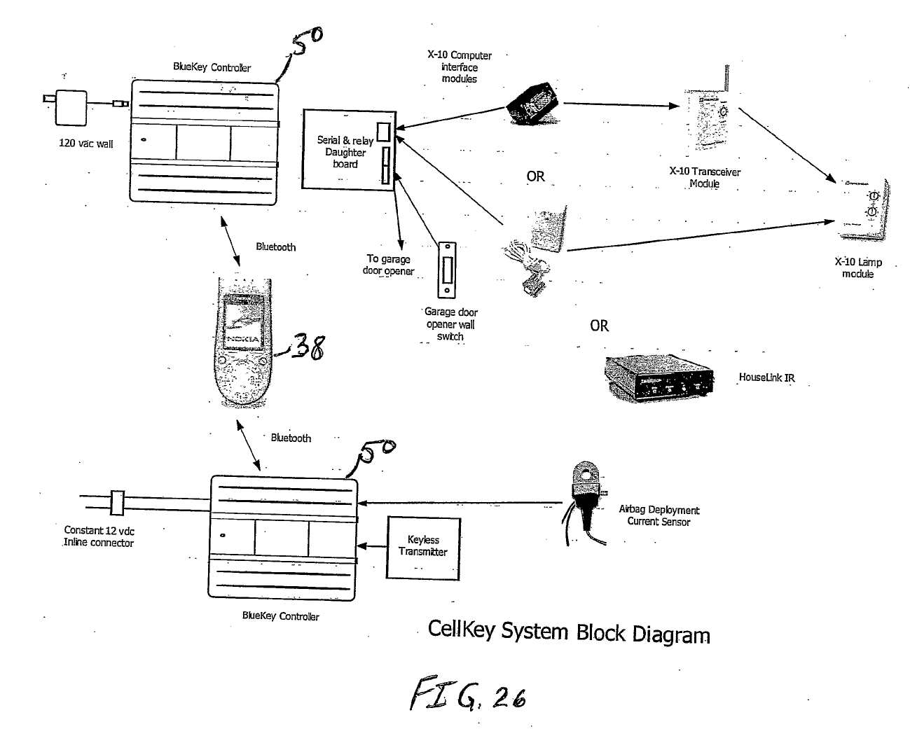

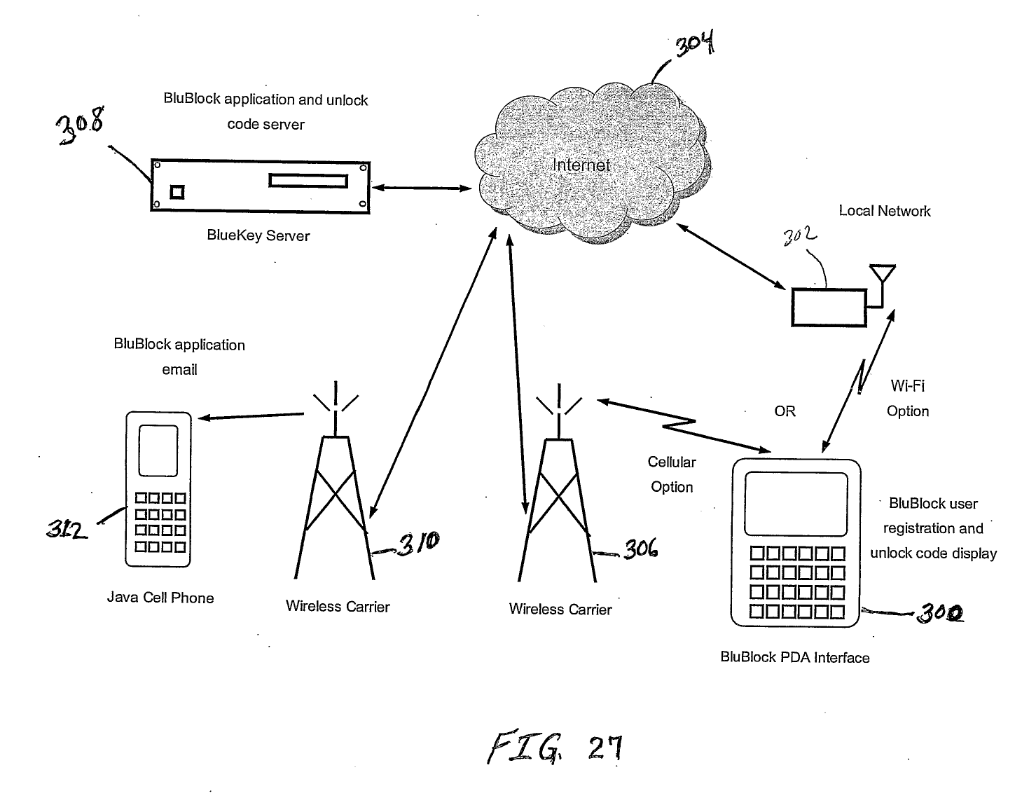

FIG. 26 shows a cell-phone operated remote control and access system. A control module 50 energized by a suitable energy source such as AC electrical power communicates with Bluetooth with cell phone 38. A serial relay daughter board is in communication with control module 50 and transmits commands to devices such as X-10 lamp modules via X-10 computer interface modules and X-10 transceiver modules. Alternatively, control module 50 can be configured to communicate with a houselink IR device to control appliances. In an alternative embodiment suitable for automobiles, control module 50 is powered by DC current and communicates with a keyless transmitter to remotely control or access devices such as airbag deployment current sensors.

FIG. 27 is a flow chart showing alternative pathways for utilizing an internet-based remote control video blocking system. In one embodiment, the system employs a video blocking application and unlock code server 308 that sends commands and signals via the internet 304 to a wireless carrier 310 that relays signals to a java cell phone 312 to block video capture or transmission via an email sent by the application. In an alternate embodiment, a command or signal is sent via the internet 304 to a wireless carrier 306 and then to, for example, a PDA interface 300 to provide user registration and unlock code displays. Alternatively, the commands or signals can be sent through the internet 304 to a local network 302 and then to the PDA interface via Wi-Fi.

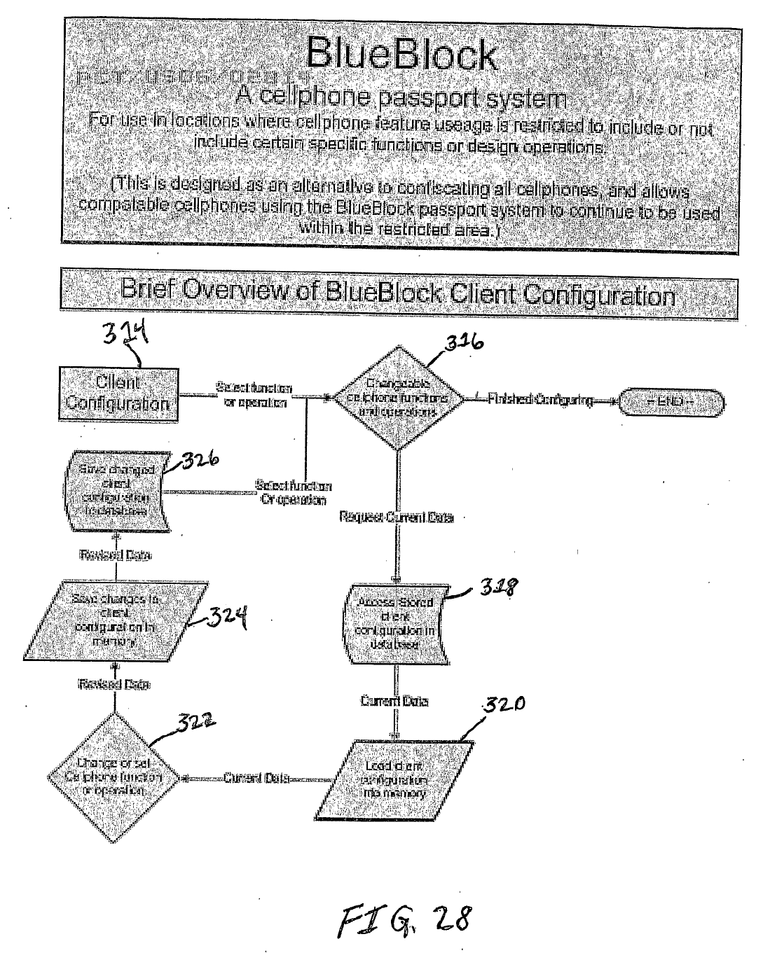

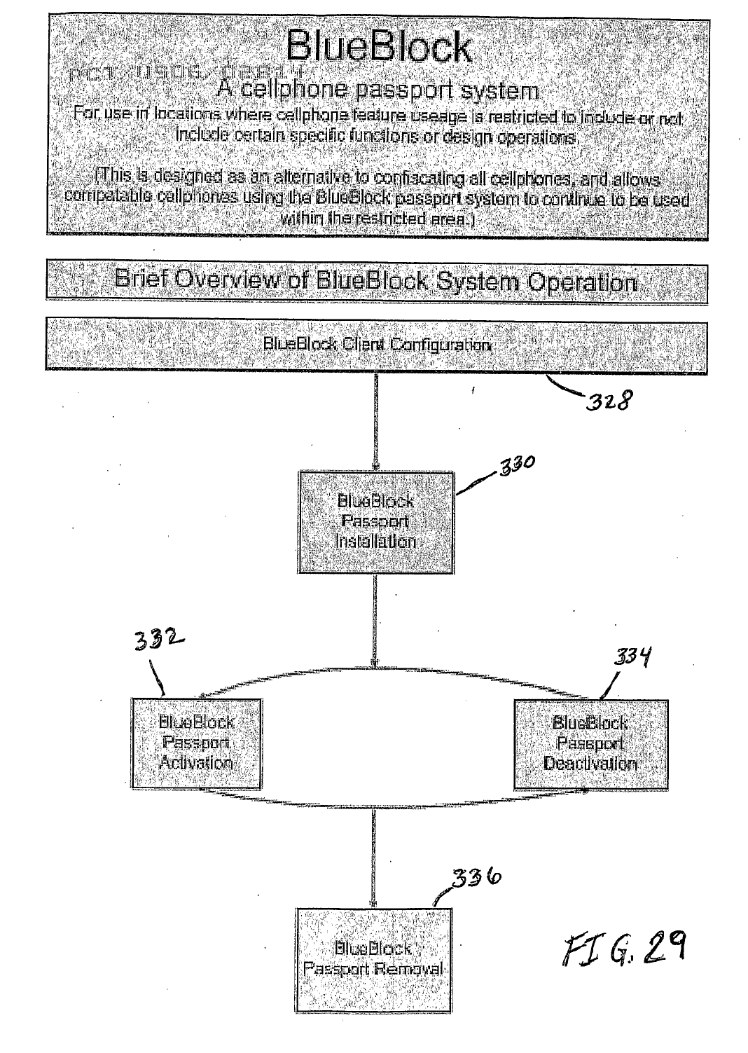

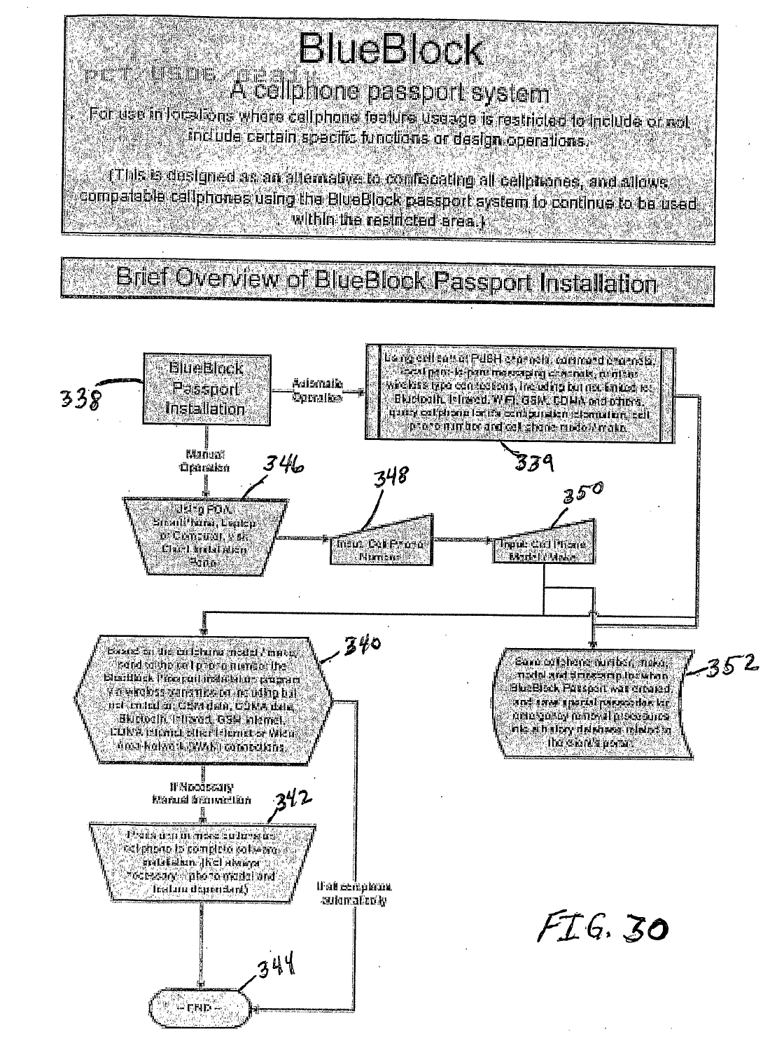

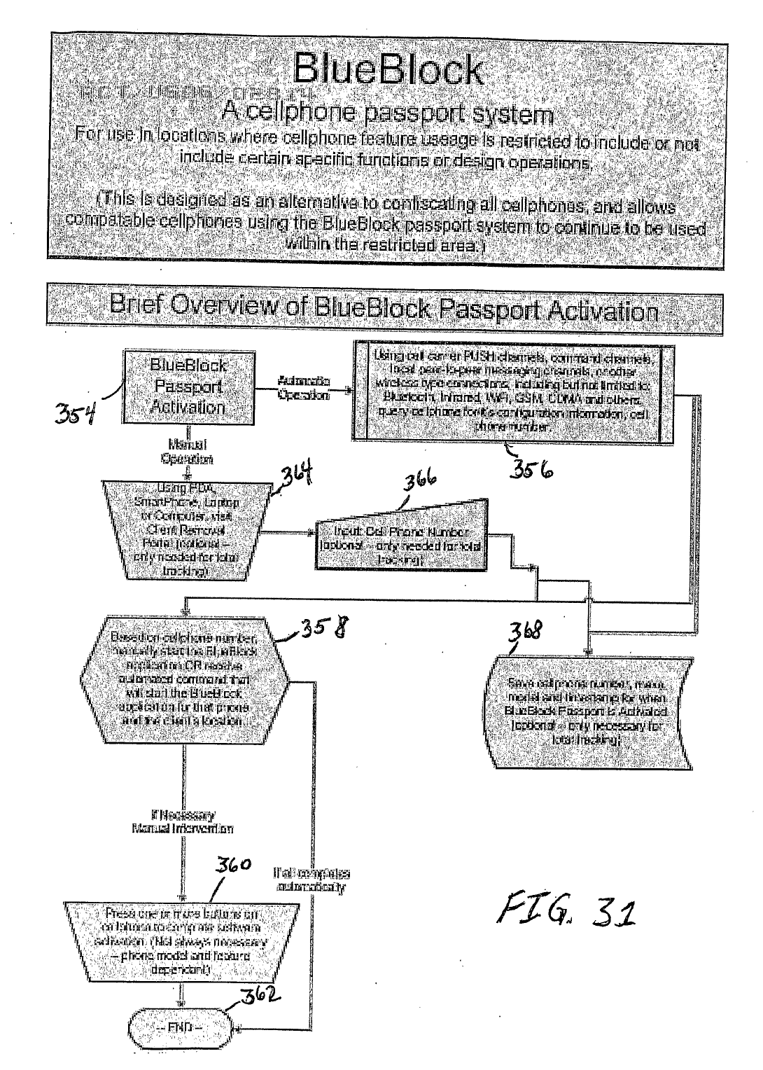

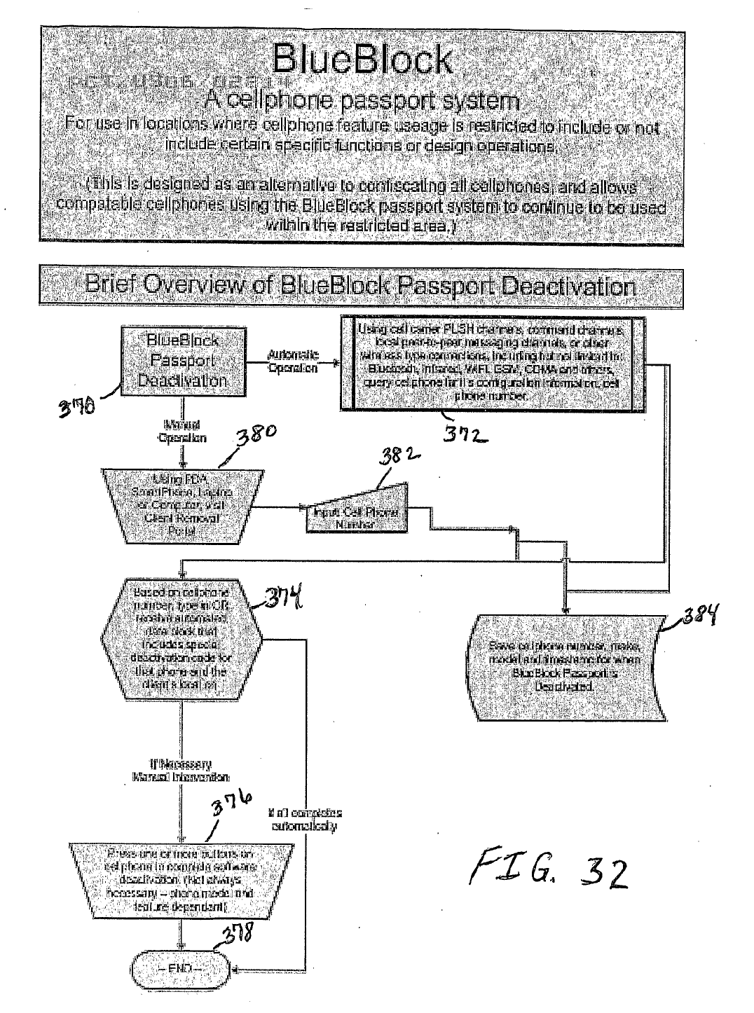

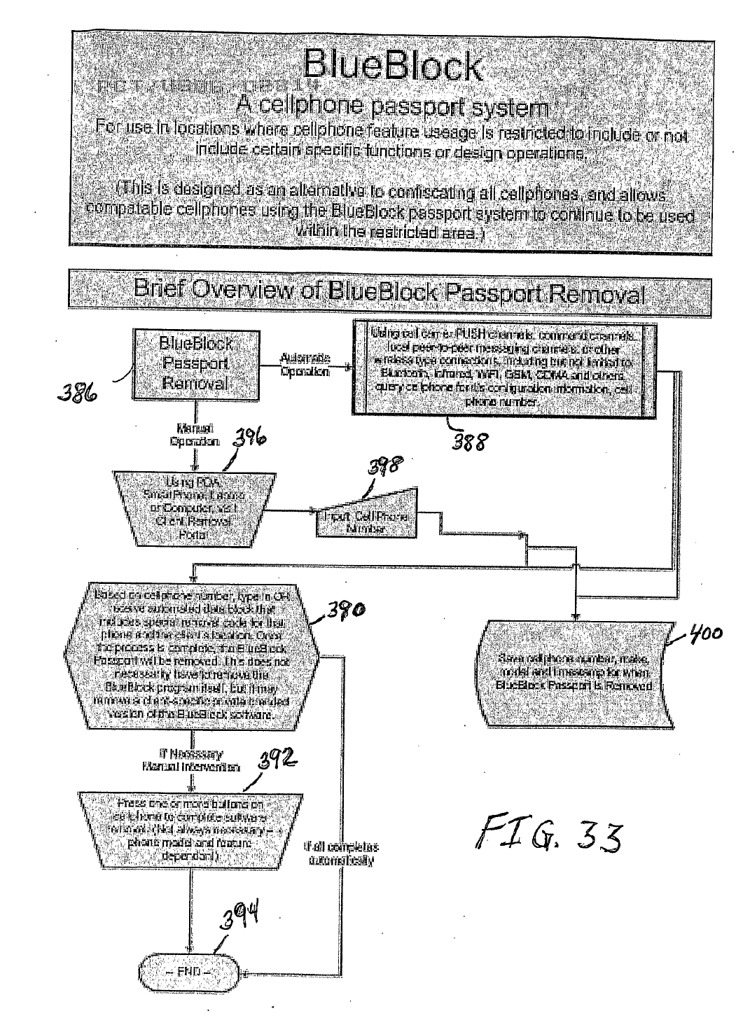

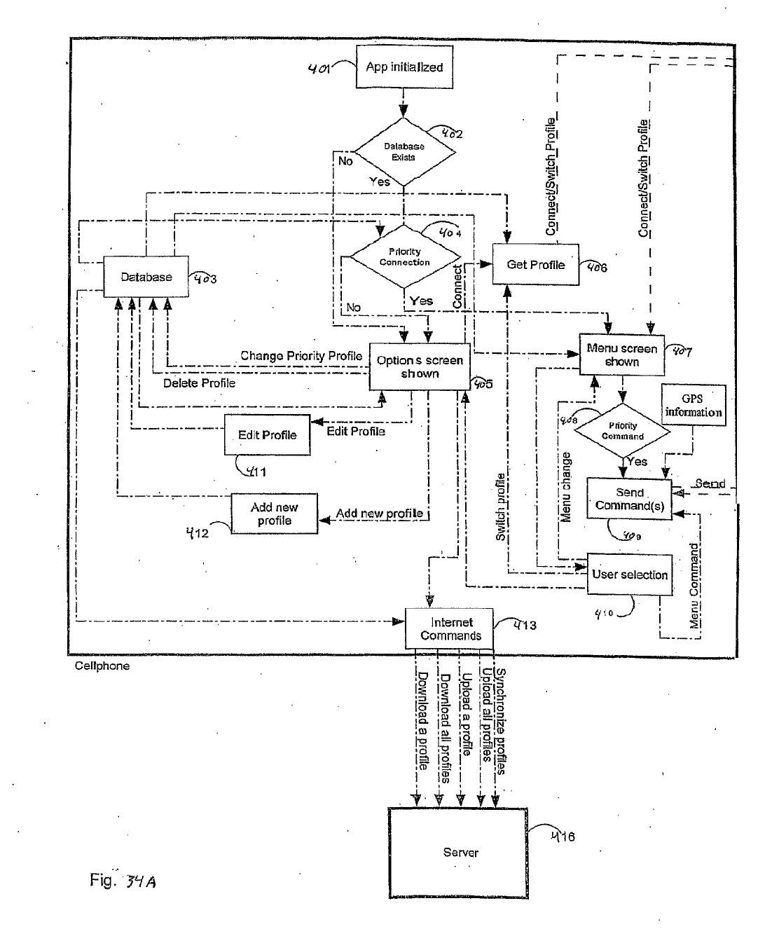

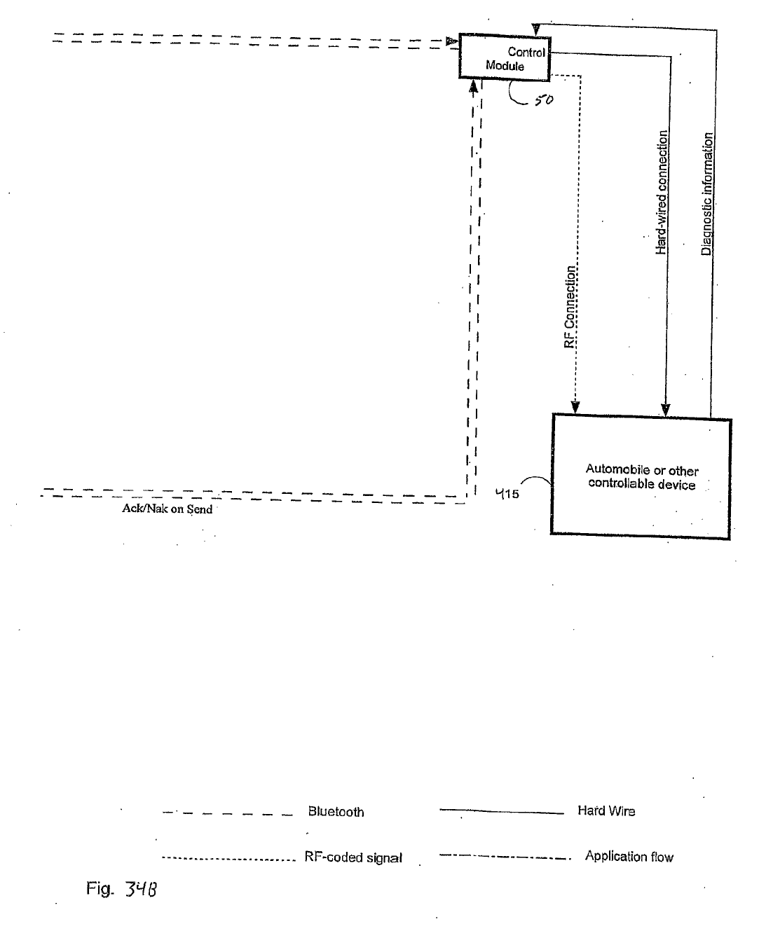

Client configuration, system operation, passport installation, passport activation, passport deactivation and passport removal are illustrated and described in FIGS. 28-33.

In another aspect of the invention, referring to FIG. 34A-B, a cell phone platform performs necessary background initializations to run the application at step 401. The application checks the file system to see if there is a database file 403 at step 402. If a database file exists, it is an essential component of the application. As used herein, database file shall mean a file or set of files stored on the cell phone platform which may be transmitted to other devices as needed such as an internet server, or the control module 50. The data stored in the file(s) minimally consists of one or more profiles, the number of profiles, the database version, and an application password string. It contains overhead information which notes the number of profiles and other control information.

As used herein, profiles shall mean a set of data defined primarily by the application user, collected together in order to be used to control a specific Bluetooth-based control module 50. This set of data minimally includes the name of the profile, a Bluetooth device address, one or more commands/macros, and names of the commands/macros. It may also include other information such as a password, text color preference, background image preference, icon preference for each command/macro, a preference for priority command/macro, preference for style of Menu Screen layout, date/time stamp for the latest modification of the profile, a string for server identification, and a string for control module 50 identification.

The more essential part of it is holding user-defined profiles. These user-defined profiles contain information such as the Bluetooth address of the device that the profile covers, defined commands/macros for the profile, graphic customization information, and other information customized to the specific profile. The database provides the information as required from various processes in the cell phone application. If a database file is present, the application checks the database for a defined priority file at step 404.

As used herein, priority file shall mean a set of data collected and defined as a profile. This instance of it is specifically marked in the database as one which should be retrieved from the database when the program begins and the information contained in it is used to attempt to establish a connection via Bluetooth transmission. The application attempts to connect to the device defined in the profile. If the connection attempt is successful, the user will be able to send commands immediately. If a priority connection is made, the options screen is shown at step 405.

As used herein, an Options Screen is a user-interface display which presents the application user with data components (either a profile listing or parts of a specific profile) to operate on in the top section of the display and operations to perform in the bottom section of the display. This allows the user to select an operation and a data component to operate on (if it is needed for the selected operation).

The Options Screen is one of two primary user-interface screens for the application. Options are presented based on whether or not there are defined profiles in the database. Functions that the user can access here control a variety of support functions for the application. This includes Adding/Editing/deleting profiles, setting passwords, Setting/Changing/Unsetting priority profile/command, Internet communication operations, and loading up and connecting with profiles for control modules 50.

If a connection is made, a profile is retrieved at step 406. With the exception of editing a profile, profiles are retrieved only when it is intended to use them to connect to a Bluetooth-enabled control module 50 (this can be one of any number of devices defined within multiple profiles, but only one device per profile) to perform remote communication/command functions. The database supplies the appropriate profile based on user selections or stored information entered by the user. The user only needs to select a new profile to connect to another control module 50 (the underlying methods are hidden from the user).

Next, a Menu Screen is displayed at step 407, the second of the two primary user-interface screens. As used herein, Menu Screen shall mean a user-interface display which presents the application use with a listing of commands/macros that have been previously defined by the user in a single profile. A section below the Main Screen provides the user with the option to select other profiles to switch to when chosen.

The Menu Screen appearance is automatically altered based on the preferences included in the profile, loaded up before this screen is presented, as well as information about the cell phone platform being displayed thereon. Whenever a profile is successfully connected to, it is checked for a defined priority command/macro at step 408.

As used herein, Command/macro shall mean a data item or set of data items defined by the user. Each data item represents a control signal which the control module 50 will send either via RF, as a substitution for an existing RF signal, or hard-wired. A command consists of only one set of these data items, while a macro may contain any number of these data items to be executed in the sequence pre-defined by the user.

If a defined priority command/macro is present, it is sent immediately. This function may work in conjunction with step 404 shown in FIG. 34A-B.

When the application has determined that it is required to send a command/macro to the Bluetooth-enabled control module 50, special routines are called to encode the transmission before passing it into the Bluetooth transmission stack. When an individual command is sent at step 409, there may be a response returned indicating that the command was not received properly. When that happens, the transmission will be sent again.

At step 410, the user may select from commands stored in the profile used when the Menu Screen was brought up, or may switch to another profile, or switch to the Options Screen. The user may select a specific profile to load up and inspect designated parts. If the user decides to change any of those parts, they can be edited at step 411, then saved to the database file.

The user may call up another interface screen which will allow them to create a new profile on the cell phone at step 412. This interface screen allows for setting a limited subset of the information contained in a profile, and performs error-checking on certain fields while it is being entered. The user may choose to discard the profile after finishing or may choose to save it to the database file.

At step 413, the user may make several requests for performing an information exchange with the server through the internet. These exchanges include downloading a selected profile, downloading all available profiles, uploading a selected profile, uploading all available profiles, and synchronizing profiles between what is stored in the database and what is on the server. For each of these exchanges, transmissions are encoded and decoded to fit defined message formats. Each of these requested exchanges may also request that the user make a decision about profile selection during these operations.

At step 414, the control module 50 is primarily intended to receive signals via Bluetooth transmission from the cell phone application and interpret those signals in order to send control signals to the device it is intended to control. If the signals it receives are not interpretable, it can send a signal to have the cell phone application re-transmit the last signal. It may also receive signals from the device it is intended to control, in order to relay information via Bluetooth transmission to the cell phone application. The control module 50 may send control signals either through non-wired transmissions, such as RF, or through hard-wired transmissions.

The functionality for the control module 50 may also include the sending or receiving of triggers for the transmission of certain information to or from the cell phone application via SMS, MMS, etc. The control module 50 may also have add-on hardware expansion units. These expansion units provide expanded functionality for command, sensors, and communication via GPS, GPRS, etc.

At step 415, a control module 50 may be hooked up to an automobile, boat, garage door, garage door opener, light switch or other system commonly controlled by an automated system, in order to control that system via the Bluetooth application on the cell phone. The controlled system may send back various diagnostic information to the control module 50. This can be information such as engine diagnostic information from an automobile's computer, the state of a light switch in the home, the state of a lock in the home, etc.

At step 416, the cell phone application may also communicate with an internet server set-up for the system. The server would allow for storage, sharing, editing, and creation of profiles for the cell phone application. Profiles that are created or edited on this server, which must be accomplished through a PC, would allow for greater graphic customization of these profiles. Sharing of profiles would also be possible, provided the user that is the intended recipient is also another authorized user of the server. Storing of profiles(s) would be accomplished by performing the appropriate upload operations through the cell phone application. Profiles may also be retrieved from storage on the server by using the appropriate download functions in the cell phone application.

Each of these operations between the cell phone and server follows a specified procedure based on which kind of request is made. They are as follows:

Download a profile:
1. Phone sends a request to a specific page with unique ID.
2. Server sends a list of headers.
3. Phone asks user which one they want to download.
4. Phone checks to see if version conflict with profile on phone. Queries user about action if there is.
5. Phone requests specific profile.
6. Server sends requested profile.
Download all profiles:
1. Phone sends request to specific page with unique ID.
2. Server sends all headers.
3. Phone resolves conflicts, asking user to do so.
4. Phone requests specified profiles by list of hash.
5. Server sends requested profiles.
Upload a profile:
1. Phone sends unique ID with a profile.
2. Server sends either okay or header & transaction number or error.
3. If not okay or error, Phone asks for permission to overwrite in each case. Sends response list if ok to replace.
4. Server responds with ok or failure.
Upload all profiles:
1. Phone sends unique ID with all profiles.
2. Serer sends either okay or error or header list & transaction number.
3. If not okay or error, phone asks for permission to overwrite in each case. Sends response list if ok to replace.
4. Server responds with ok or failure.

### Synchronize:

1. Phone sends unique ID with all profiles.
2. Sever compares with current records, discards duplicates, and incorporates new profiles.
3. Server sends back profiles, list of hashes for phone-created profiles in order of profiles that were sent, and headers for profiles with existing versions.
4. Phone queries user for profiles with existing versions. Sends back list of hash with code to indicate whether to overwrite on server or send full profile to phone.
5. Server overwrites and/or sends out profiles.
6. Phone writes any new profiles.
Each of these operations has its own set of proprietary message formats for all messages in the operation. The message formats cannot be disclosed for this document due to the need to protect the security of user information.

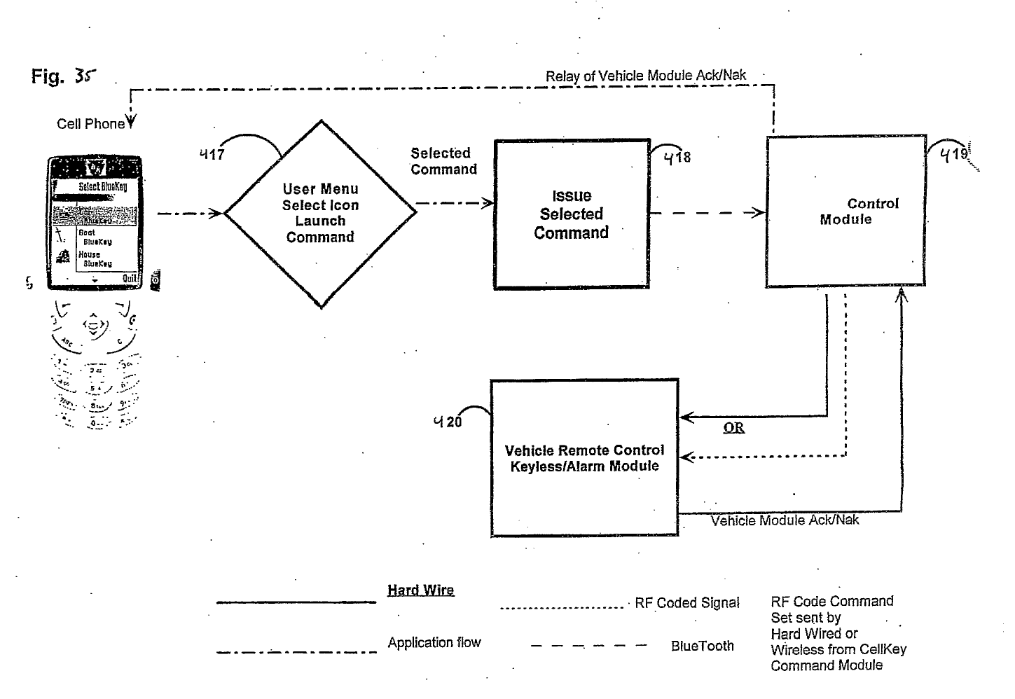

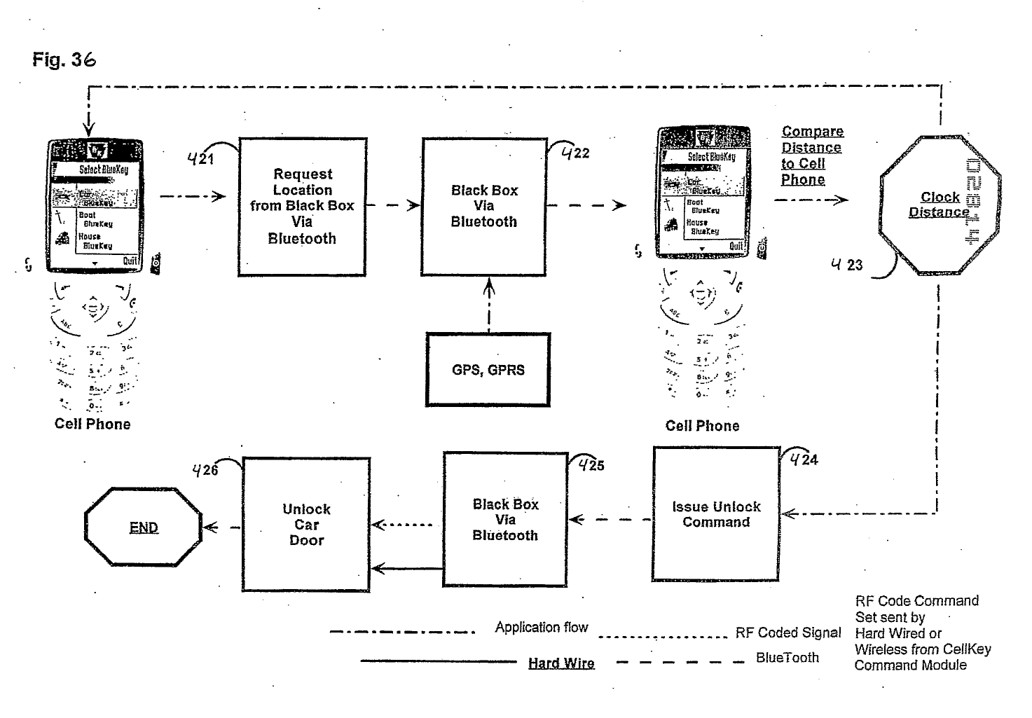

Referring now to FIG. 35, at step 417, the user chooses commands to be sent from this screen. This step corresponds to step 407(shown in FIG. 1A-B), on the Menu Screen shown.

At step 418, the commands chosen will either be sent through a command sub-system which interprets what was chosen, and sends (and as necessary re-sends) the chosen command to the control module 50. These commands may include, but are not limited to: locking, unlocking, and toggling car door locks; opening, closing, and toggling car windows; opening a car trunk; locking, unlocking, and opening a car hood; staring a vehicle engine; opening a vehicle fuel filler cap; opening and closing an automobile's panel doors; activating and deactivating a vehicular alarm system; turning on and off vehicle lights; and opening and closing of a garage door.

At step 419, the application handles decoding and relay of signals between the cell phone application and the automobile. This corresponds to step 414 shown in FIG. 34A-B.

At step 420, the cell phone receives signals from the Command Module either via RF or a hard-wired connection. It may send signals back to the control module 50 via a hard-wired connection.

Referring now to FIG. 36, at step 421, the command sub-system interprets the chosen command and sends a request to the control module 50. This corresponds to step 409 shown in FIG. 34A-B.

At step 422, the module responds, if able, to the request from the phone. This corresponds to step 414 shown in FIG. 34A-B.

At step 423, the command sub-system checks to see if the response from the control module 50 indicates it is in range to send the unlock command. The method for doing so will depend upon the available resources. If only a basic Bluetooth connection status is available, it will determine range based on whether or not there is a Bluetooth connection between the cell phone and command module 50. If a Bluetooth signal strength is available, range will be determined based on a combination of the signal strength and previously noted connection qualifier. If a GPS and/or GPRS module has been attached to the command module 50, the signal strength and navigational information from these add-on modules will be used to determine the distance. If the cell phone is determined to not be in range, the process starts again at step 421. This corresponds to step 409 shown in FIG. 34A-B. It is contemplated with an amplified system, the range of reception using the Bluetooth protocol, will exceed 100 meters and possibly exceed 120 meters.

At step 424, the command sub-system has determine that the command module 50 is in range and transmits the unlock command signal. This corresponds to step 409 shown in FIG. 34A-B.

At step 425, the control module 50 interprets and relays signals to the automobile to unlock the car door. This corresponds to step 414 shown in FIG. 34A-B.

At step 426, the car door is unlocked after receiving a signal from the control module 50. This corresponds to step 415 shown in FIG. 34A-B.

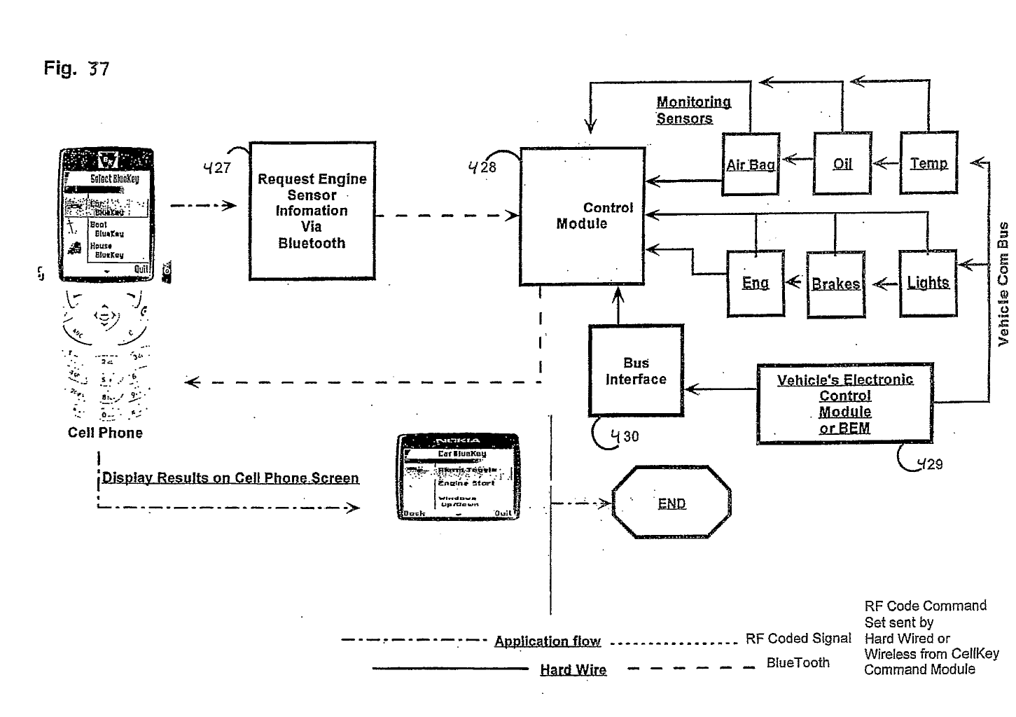

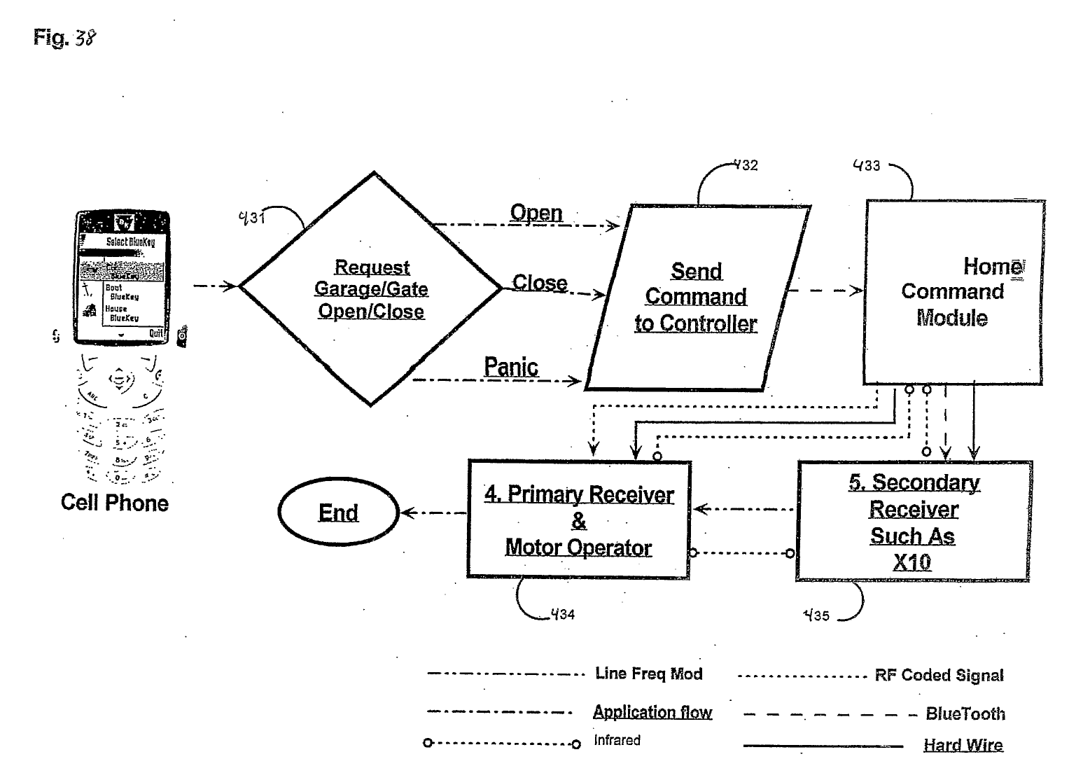

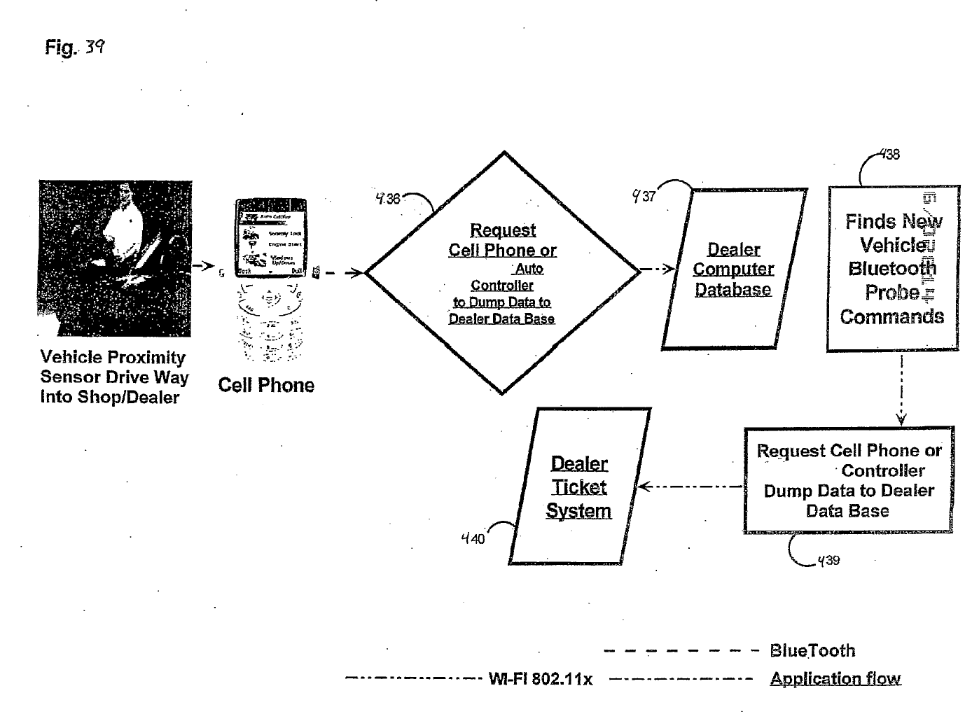

Referring now to FIG. 37, at step 427, the command sub-system interprets the user selection and sends the appropriate signal to the control module 50. This corresponds to step 409 shown in FIG. 34A-B.

At step 428, the control module 50 interprets the signal from the cell phone application and sends the appropriate command via either RF or a hard-wired connection. Once it receives a response from the automobile, it relays the information to the cell phone application. This corresponds to step 414 shown in FIG. 34A-B.

At step 429, the automobile gathers the appropriate diagnostic information and sends it to its Vehicle Com Bus to the Bus Interface device. This corresponds to step 415 shown in FIG. 34A-B.

At step 430, the bus interface may be supplied by a third party. The purpose of the device will be to collect the information from the Vehicle's Electronic control module and output it through a communications channel that the control module 50 will be able to receive (such as RS-232).

Referring now to FIG. 38, at step 431, the user chooses a command to be sent. This corresponds to step 410 shown in FIG. 34A-B.

At step 432, the chosen command(s) will either be sent through a command sub-system which interprets what was chosen, and sends (and as necessary re-sends) to the home control module 50. This corresponds to step 409 shown in FIG. 34A-B.

At step 433, the home command module handles the decoding and relaying of signals between the cell phone application and the controlled device. This corresponds to step 414 shown in FIG. 34A-B.

At step 434, the controlled device may be a gate operator or one of many other devices such as appliances, home electronics, lights, stereo, etc. The device receives signals from the command module 50 either via RF, infrared, or other hard-wired connection. It may send signals back to the command module 50 via a hard-wired connection. This corresponds to step 415 shown in FIG. 34A-B.

At step 435, if necessary for the home command module to send signals to another control device in order to control the target device, it may do so as needed.

Referring now to FIG. 39, at step 436, the user has chosen to query the vehicle dealer's database for verification information. This corresponds to step 410 shown in FIG. 34A-B.

At step 437, the dealer's database provides verification information in order for the cell phone application to know that it is an appropriate receiver and how to communicate with it.

At step 438, the cell phone application command sub-system gathers information from the automobile via the command module 50 as shown in FIG. 37 (View Engine Monitoring Sensors).

At step 439, the cell phone application queries the user about whether they wish to send the gathered information to the dealer's database.

At step 440, if the cell phone application obtains permission, it will send the information to the Dealer's ticket system. This corresponds to step 409 shown in FIG. 34A-B.

Referring now to FIG. 40, at step 441, the cell phone application will be used to start the alarm/locator on a Personal Location Device 402. It will then receive signal from the locator device and wait for the signal to stop before sounding an alarm signal to the user. The cell phone application may be instead used to alert a network of control modules 50, installed in either a residential or office building to start monitoring for a Personal Location Device 402. In this case, the alarm signal on the phone will be triggered if all control modules 50 in the network stop receiving signal from the location device.

The Personal Location Device 402 will continuously transmit a signal once activated. The signal may be transmitted via either Bluetooth or another RF-coded signal. The means of determining range are the same as described in FIG. 37 steps 421-423. The locating signal may be transmitted in response to a cell phone application or one or more control modules 50.

At step 443, if a control module 50 is used as part of this system, it can serve a variety of functions. The first would be as a range extension in order to track the Location Device 402. If used as part of a network of control modules 50 and GPS is not available, another function would be to establish position of the Location Device 402 by establishing which modules 50 in the network can receive the location signal. Another function, whether or not the control module 50 has GPS would be logging of location information for a given Location Device 402. This logged information can then be transmitted to a pre-designated computer for analysis of the information. The transmission to a computer may take place over a number of transmission mediums including, but not limited to, Bluetooth, RF-coded signals, and hard-wired connections. This corresponds to step 414 shown in FIG. 34A-B.

As shown at step 444, a computer that is used to retrieve location information from a control module network for a location device can perform several functions in this role. The first is to act as another point where an alarm signal appears to a user if it used to monitor logs in real-time situations. Another would be to show the last know location of the location device before the transmitting within network range or last location and direction if the device has left the alarm range. As another function the logs from the network could be used to simply trace where the path that the location device took while the network tracking was active.

Referring now to FIG. 41, at step 445, the role of the customer's cell phone in the general system layout (shown in FIG. 34A-B) will primarily be requests for application and profile download (as well as profile upload). This may include a secondary role of the cell phone to download programs or data to be relayed to a control module 50.

At step 446, the control module 50 in the vehicle will normally play no role in the general system layout. It may also include a role where it may be the receiver of new programs or data from the customer's cell phone. These downloads would implement bug fixes, upgrades to firmware, expanded functionality for the module (either in terms of hardware add-ons or other software), and other similar functions.

The role of the Wireless Carrier 447 will be to relay communication between the Internet and the customer's cell phone as described more fully herein. The Colo Servers 448 will act as the primary source and storage for applications to download various account-specific information such as: profiles, log-in identification, etc.

The Backup ISP 449 will come into the system in the case that the Colo Servers are unable to perform their assigned functions for any reason. Should this occur, these will become active by means of namespace re-allocation. At times other than this, the only participation that the Backup ISP will have in the system will be to receive updates of the current available application downloads and current customer information.

The Administration Office 450 will communicate with Colo Servers 448 and Backup ISP 449. Namespace switching will be initiated here as needed. New versions of the application will also be sent from here to the Colo Servers 448. Other administrative duties over the Colo Servers 448 and Backup ISP 449 may also be performed from here.

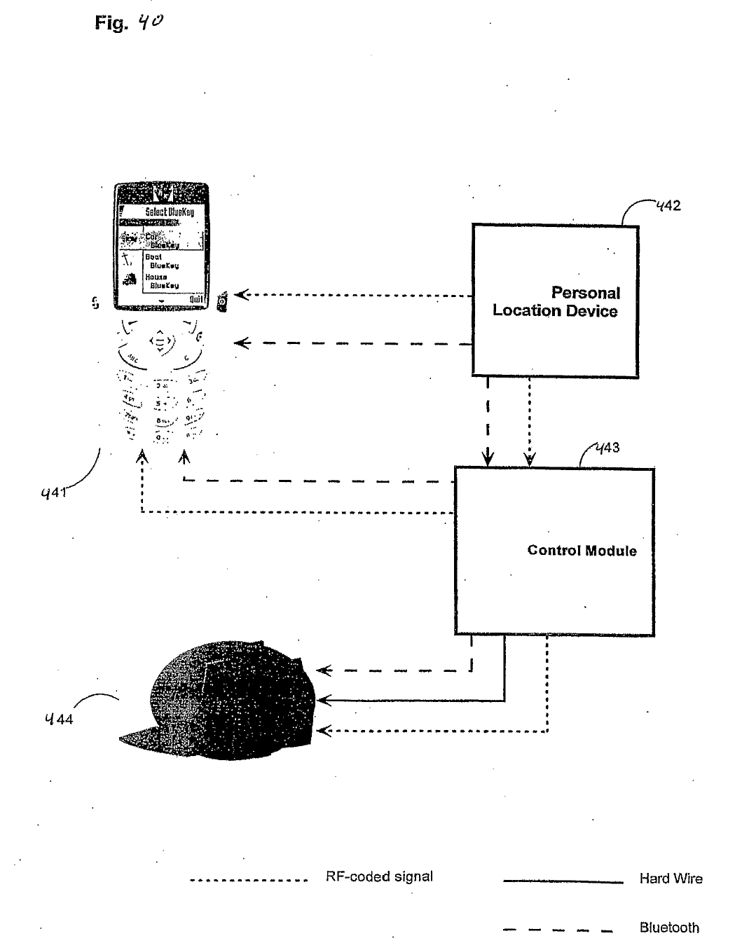

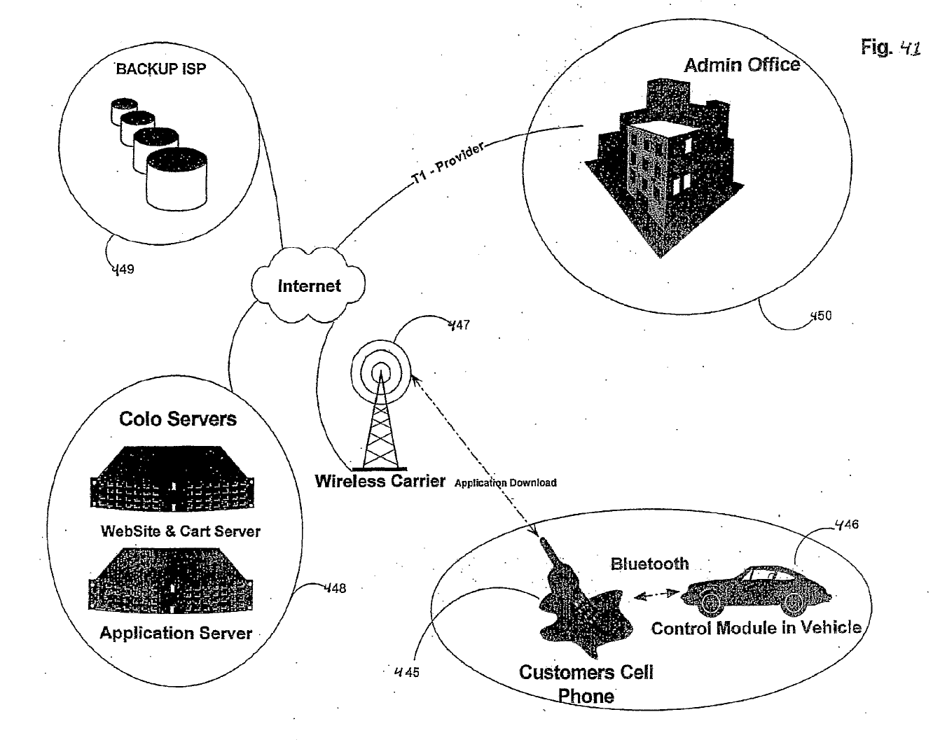

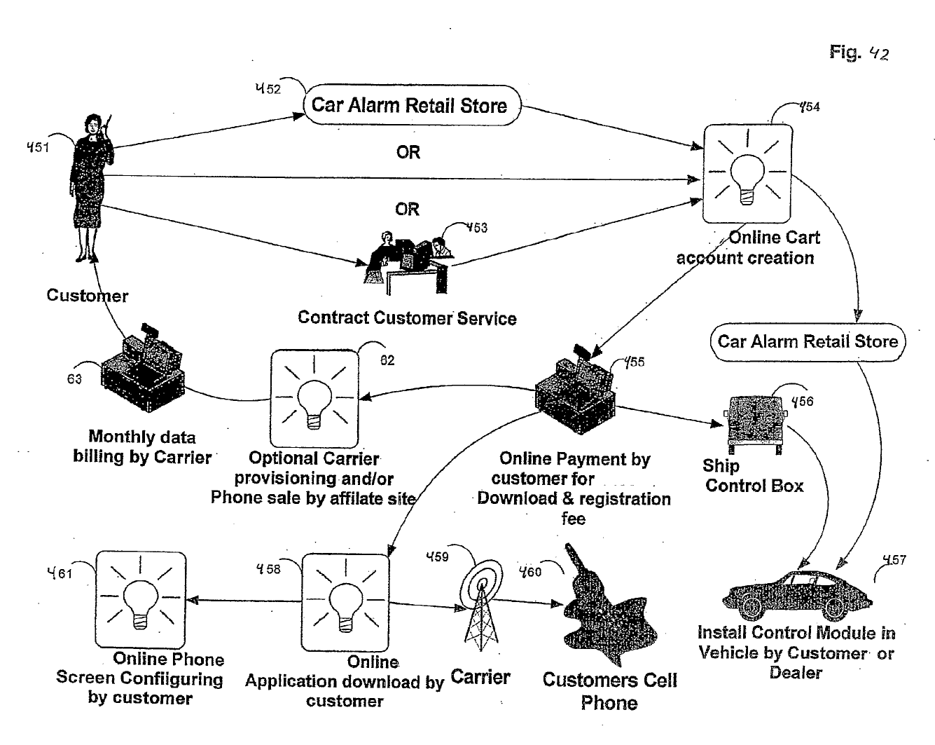

Referring now to FIG. 42, the customer 451 may choose from among one of three methods to get the application installed. The first is by purchasing a packaged unit at a car alarm retail store 452. Another would be calling the Contract Customer Service 453 telephone number. The option would be using the Internet to directly connect to the portal-based web server. A car alarm retail store would perform several functions. When the system is purchased there, they may connect to the web server to create an account for the customer. Whether or not they create this account, the retail store may also install the control module 50 in the vehicle for the customer. Contract Customer Service 453 will collect the necessary information from the customer and enter the needed information into the website systems to create an account for the customer.

An online account creation 454 will collect the minimum amount of details to insure that the customer can receive the items needed to use the system. The online system will then collect information to allow for payment of the system at step 455. After details are entered into the online system at step 456, a control module 50 may be shipped by a selected courier service if the customer ordered it. Once the customer has a control module 50, they may install the module on their own at step 457. They may also have the store or dealer that sold it to them, or other sufficiently knowledgeable person install it for them.

After payment at step 458, a customer can download the cell phone application to their cell phone, either via the Internet if they have created an account, or via media from a package they have purchased at a store or dealer. When downloading from the Internet at step 459, the customer will have to receive the application through their wireless carrier. At step 460, the cell phone application will ultimately be loaded onto a compatible cell phone, whether it is downloaded from the Internet or installed from media included in a retail package. Once a customer has downloaded an application from the Internet at step 461, they may access and use the web server to configure information for their custom profiles. This may be accomplished using a cell phone but will be accomplished more easily using a desktop or laptop computer system that has access to the Internet.

While the customer is purchasing the system, they will also have the opportunity to make other related purchases at step 462. These include a cell phone carrier service, either in replacement of their current one or for a new phone. They may also purchase a new cell phone from among models that are compatible with the system. The customer may be sent a monthly bill for data services by their cellular carrier service at step 463.

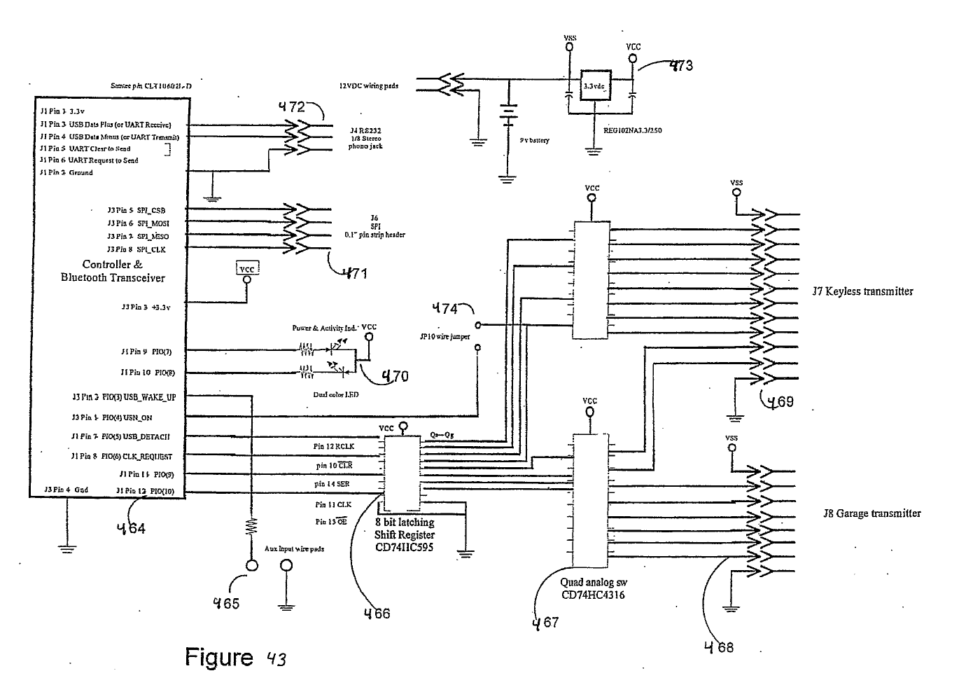

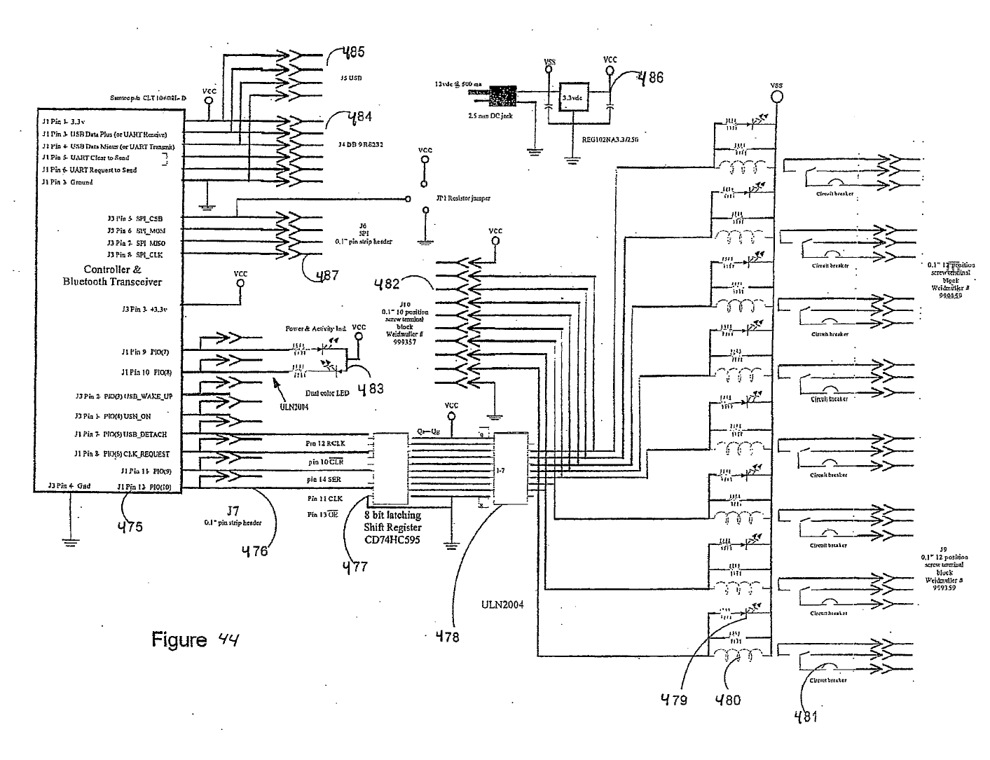

Referring now to FIG. 43, the controller and Bluetooth Transceiver 464 consists of a microcontroller that processes all communications between the control module 50 and the Bluetooth transceiver. This microcontroller also controls all circuit logic functions and database functions. The transceiver also contains the Bluetooth transceiver circuit and protocol stack. The controller uses flash memory for program firmware and database operations. The circuit communicates with output logic through the GPIO buss 465 in serial clocked format.

The CD74HC595 466 is an eight-bit latching shift register used to convert serial data into parallel outputs for the onboard relays. The shift register can have any amount of outputs active at any one time. The clocked data on GPIO buss 465 in clocked in sequence and then latched upon clk (pin 11) signal returning low. When the serial data (pin 14) is logic high and clk (pin 11) is logic high a logic high is loaded into the q1 of the shift register. The next received clk pulse will push the q1 logic level to the next register in sequence. This sequence is repeated until 8 clk pulses have been sent. When the q0-q7 outputs are logic high, this will be considered active outputs to the relays.

The CDHC4316 467 is a Quad analog switch circuit. The outputs are high impedance when off and very low impedance when active. Each analog switch output is connected across the individual keypad switches of the installed vehicle key FOB keyless or alarm transmitter. When the variable modulation frequency and variable protocol output transmitter circuit is connected, the analog switch circuit will not be installed and instead transmitter data line will be jumpered (j10) to send the universal-output transmitters microcontroller information to configure the modulation frequency and protocol to be transmitted.

A first set of internally used connectors 468 are used to interface with the PCB mounted Key FOB transmitters or variable modulation frequency and variable protocol output transmitter circuit. VSS DC power is made available to the transmitter's voltage source.

A second set of internally used connectors 469 are used to interface with the PCB mounted Key FOB transmitters or variable modulation frequency and variable protocol output transmitter circuit. VSS DC power is made available to the transmitter's voltage source.

Power and Activity indicators 470 are visible to the outside and used to verify that power is available to the circuit and to indicate when the circuit is receiving and transmitting data through the Bluetooth interface to the mobile device. There are various status blinking series to indicate operational errors in these functions.

A SPI interface 471 is an external programming connection for use in the production process.

An RS232 serial port 472 is used to communicate with optional external devices or circuits such as navigational devices, computer interface, and vehicle's data buss interface or any other serial communicating device.

A voltage regulator circuit 473 converts the DC voltage source such as vehicle power to an AC or DC power supply or wall adaptor power supply to 3.3 v for circuit component operation. Power input is direct hardwired to the vehicles power or uses the internal rechargeable or replaceable battery.

A jumper 474 is used when the universal-output transmitter is installed instead of the OEM transmitter. The universal-output transmitter can take the place of most OEM or third party transmitters.

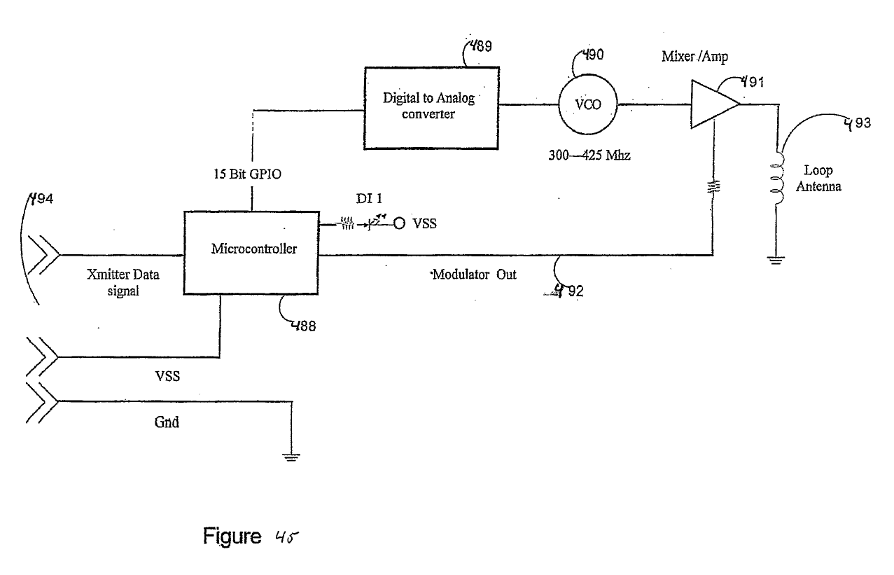

Referring now to FIG. 44, the home-based Controller and Bluetooth Transceiver 475 consists of a microcontroller that processes all communications between the control module 50 and the Bluetooth transceiver. This micro controller also controls all circuit logic functions and database functions. This Controller and Bluetooth transceiver also contains the Bluetooth transceiver circuit and protocol stack. The controller uses flash memory for program firmware and database operations.

The Controller and Bluetooth transceiver circuit communications with output logic through a GPIO buss 476 in serial clocked format.

A CD74HC595 477 is an eight-bit latching shift register used to convert serial data into parallel outputs for the onboard relays. The shift register can have any amount of outputs active at any one time. The clocked data on GPIO buss 476 in clocked in sequence and then latched upon clk (pin 11) signal returning low. When the serial data (pin 14) is logic high and clk (pin 11) is logic high a logic high is loaded into the q1 of the shift register. The next received clk pulse will push the q1 logic level to the next register in sequence. This sequence is repeated until 8 clk pulses have been sent. When the q0-q7 outputs are logic high, this will be considered active outputs to the relays.

A ULN2004 478 contains 7 buffered line drivers with EMS protection. These Darlington configured transistors will sink large enough current to activate the relay coils. LED 479 will emit light during activation of the relay. The LED is visible on the outside edge of the circuit board.

Eight relays 480 are SPDT contacts to allow variable contact closures. These contacts are brought out to PCB mounted screw terminal connection block for wire attachments. An auto resettable circuit breaker 481 prevents damage to the circuit board traces during a short circuit of the relay contacts.

ULN2004 sinking outputs 482 are made available through a connector as additional or alternative outputs when high switching currents are not required. VCC power is also made available at this connector to power external devices or circuits.

Power and Activity indicators 483 are visible to the outside and used to verify that power is available to the circuit and to indicate when the circuit is receiving and transmitting data through the Bluetooth interface to the mobile device. There are various status blinking series to indicate operational errors in these functions.

An RS232 serial port 484 is used to communicate with optional external devices or circuits such as navigational devices, computer interface, and vehicle's data buss interface or any other serial communicating device.

A USB port 485 is used to communicate with optional external devices or circuits such as navigational devices, computer interface, and vehicle data buss interface or any other USB communicating device.

A voltage regulator circuit 486 converts the DC voltage source such as vehicle power to an AC or DC power supply or wall adaptor power supply to 3.3 v for circuit component operation. Power input is direct hardwired to the vehicles power or uses the internal rechargeable or replaceable battery.

A SPI interface 487 is an external programming connection for use in the production process.

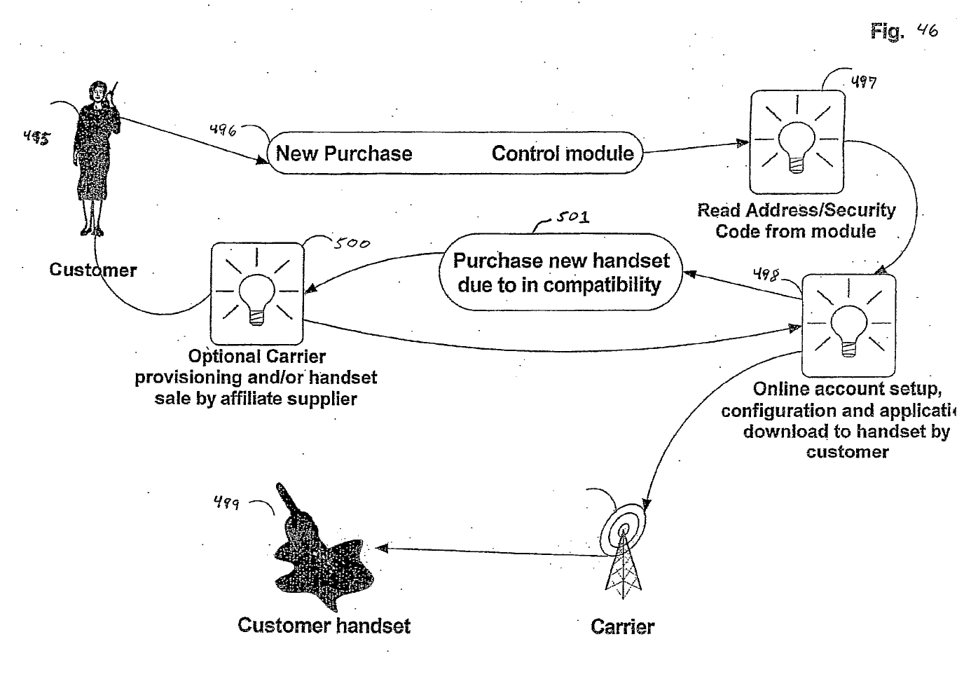

Referring now to FIG. 45, the microcontroller 488 inputs the transmitter data signal and extracts the values for the D/A converter in a 15 bit resolution. This 15 bit output is latched until the transmission is complete. A D/A 489 converts the 15 bit input to an analog level controlling the VCO's output between 300 Mhz to 425 Mhz. A VCO output signal 490 is input to the transmitter's amplifier.

A Mixer/Amp 491 output matches the incoming VCO frequency when the Modulator Out (5) is active. When the Modulator Out (5) is inactive, the Mixer/Amp output is 0 Mhz.

A modulator 492 out signal contains all protocol and data to be modulated. The output is Amplitude Modulation at 100%.

A loop antenna 493 consists of a trace circuit on the PCB. This antenna is tuned to propagate the modulated data between 300-425 Mhz. An input connector 494 connects to the Automotive PCB circuit via J7 and utilizes VSS, Ground and transmitter data signal.

Referring now to FIG. 46, when a customer 495 desires to remotely control devices via a mobile handset, customer 495 may choose from among one of three methods to get the system installed. The first is by purchasing a packaged unit at a Retail Store 496. Another would be calling the Contract Customer Service telephone number. The final would be using the Internet to directly connect to the system's retail website.

At step 497, the customer/installer locates and writes down the serial number found on the control module 50 housing. Next, at step 498, on an Internet connected computer, the customer types in the web address for the web server and follows the step-by-step account setup procedure on the website to register the handset and configure the application. After completing the registration and configuration process, the portal will send a SMS to the handset with a go to link. This link will connect the handset 499 to the portal application server for downloading and installing the application. The downloading and installation process is interactive and requires the user to follow the prompts. During the downloading process the application server will query the mobile device for the model number to determine if the device is compatible with the application. The server will then connect to various mobile device compatibility databases to lookup the devices for system compatible characteristics. If it is determined from the model number query to be incompatible for application, the downloading process is terminated and the customer is informed through SMS messaging and/or the portal that the mobile device is incompatible.

A list of compatible mobile devices is provided and listed for the customer to replace the existing mobile device at step 500. A compatible mobile device may be purchased online by the system provider and/or its affiliates or through a cellular carrier that offers a compatible model at step 501.

When downloading from the portal, the customer will have to receive the application through their wireless carrier or other cellular transceiver systems. The application will ultimately be loaded onto a compatible mobile device, whether it is downloaded wirelessly or via a hardwire connection.

An Internet-user can access the portal site via HTTP protocol over TCP/IP networking from the Global Internet. From a Marketing site, a user may access the main portal marketing pages. A login page allows a user to enter the user's ID and password for an existing account. A user login validation is performed by the Portal. The Portal validates the user ID and password against the encrypted records in the database.

Assuming a valid ID is confirmed, the first step to create an account is to have a user without a previous account to create one by entering a user ID to be used and an email address to be associated with the account.

Once this information is entered, the portal creates a randomized password and generates an SMTP-compliant email containing the password to the user, along with a unique URL back to the email verification page.

The user receives the generated email and uses the contained URL to return to the portal. The user enters the user's ID and password to confirm the email address. The portal verifies the user ID and password against encrypted data within the database.

The next step to create an account requires the user to enter a mailing address, billing address and payment details for storage in the database. The user enters the Bluetooth address of the receiver (transceiver) to be stored in the database.

An initial profile is created with minimal data and stored in the database. An application download page explains the process of application download and prompts the user to continue. The download is preceded by an optional email generation to send a unique URL that is generated based on the user ID and receiver's Bluetooth address to identify the customer in succeeding steps.

The unique URL is entered into the cell phone, which connects using standard HTML or WAP browser. A preparatory page for the user, a download page for cellular phone applications is downloaded prior to download of the application. A copy of the application for the phone model being used by the user is branded with a unique identifier. The branded application is transmitted to the phone. This is followed by an image download, which is a script that allows the application to download needed image media.

This is followed by a profile download, which is a script that allows the application to download profiles. The system then performs a customer identification to determine whether the sender is the customer in question from the unique ID sent by the application.

The portal next determines whether a password recover has been performed since the last time a manual password reset has occurred. If so, a manual reset is forced. If needed, the customer may institute a password reset by entering a new password. Assuming the user makes it to this point, a product page is sent, which is a menu page that links to other portal functions.

The portal will list stored profiles for currently logged-in users. The system allows the user the option to edit a stored profile or create a stored profile. With respect to account and billing information, the user may edit the stored mailing address, billing address, and payment details.

Customer details are made accessible to dealers and customer service logins only to allow viewing of details of another account.

If a user cannot remember the user password for his/her account, the user may use a password recovery page and enter a user ID or email to begin the password recovery process. The customer is prompted to enter an answer to a stored question to verify identity. If successfully answered, the user may obtain a new password. The portal creates a randomized password and generates an SMTP-compliant email containing the password to the user. The email redirects the browser back to the portal login screen so that the user may enter the new correct password to gain access to the system.

Having described the invention, it should be understood that the foregoing description of the invention is intended to merely be illustrative thereof and that other modifications, embodiments and equivalents may be apparent to those skilled in the art without departing from its spirit.

Having thus described our invention, what we claim as new and desire to secure by Letters Patent is:

1. A remote access and control communication system comprising:
a handheld mobile communication device having a transceiver;
a second transceiver configured for transmitting and receiving RF signals from the cell phone transceiver;
a device remote from the mobile communication device and second transceiver in communication with the second transceiver.

2. The system of claim 1 wherein the mobile communication device and second transceiver communicate with a Bluetooth communication protocol.

3. The system of claim 2 wherein the mobile communication device transceiver and second transceiver are amplified to provide a communication range greater than 100 meters.

4. The system of claim 1 wherein communication signals between the mobile communication device and second transceiver are encrypted.

5. The system of claim 1 wherein the mobile communication device transceiver is configured to send and receive variable code and frequency signals.

6. The system of claim 5 wherein the second transceiver is configured to send and receive variable code and frequency signals.

7. The system of claim 1 wherein the second transceiver is installed into an automobile.

8. The system of claim 7 wherein the device comprises at least one of vehicle diagnostic information, car door lock operation, door opening operation, window operation, sun roof operation, environmental controls operation, trunk operation, fluid level operation, gas cap operation, hood operation, engine exhaust monitoring operation, air bag status and operation, radio operation, ignition operation and braking operation.

9. The system of claim 8 further comprising a plurality of cell phones having transceivers configured to communicate with the second transceiver.

10. The system of claim 8 wherein the plurality of cell phones communicate with the second transceiver using a Bluetooth communication protocol.

11. The system of claim 1 wherein the device comprises at least one of vehicle diagnostic information, navigation system, car door lock operation, door opening operation, window operation, sun roof operation, environmental controls operation, trunk operation, fluid level operation, gas cap operation, hood operation, engine exhaust monitoring operation, air bag status and operation, radio operation, ignition operation and braking operation.

12. The system of claim 1 wherein the second transceiver is installed in a building.

13. The system of claim 12 wherein the device comprises at least one of a building alarm system, building fire system, perimeter access, commercial, residential, auto, door bell, garage door opener, light system, home appliance, stereo system, audio/visual system, video monitoring system, building door lock system, telephone systems, Internet systems, Satellite systems, cable systems, cable settop box, game box, heating system, air conditioning system, and HVAC system.

14. The system of claim 13 wherein the device is hard wired to the second transceiver.

15. The system of claim 13 wherein the device is configured to receive RF signals from the second transceiver.

16. The system of claim 15 wherein the device includes a transceiver for transmitting and receiving RF signals from the second transceiver.

17. The system of claim 16 wherein the device communicates with the second transceiver using a Bluetooth communication protocol.

18. The system of claim 1 wherein the handheld device is a cell phone, personal digital assistant, blackberry device, and portable computer.

19. A portal-based remote access and control system comprising:
a handheld mobile device having a transceiver;
a second transceiver configured to communicate with the handheld mobile device transceiver;
a device, remote from the mobile device and second transceiver, configured to communicate with the second transceiver; and,
an application for sending and receiving secure transmissions installed in the handheld mobile device.

20. The system of claim 19 wherein the application is downloaded into the mobile handheld device from the Internet.

21. The system of claim 19 further comprising a remote administrator having a Web server for remotely administering the application downloaded into the mobile device.

22. The system of claim 21 further comprising means for creating user identification data for storage on the mobile device.

23. The system of claim 22 further comprising means for sending identification data stored on the mobile device to the Web server for identity verification.

24. The system of claim 23 further comprising means for verifying identification data received by the Web server from the mobile device.

25. The system of claim 24 further comprising means for recognizing the identification data by the second transceiver.

26. The system of claim 25 further comprising means for storing the identification data on the second transceiver.

27. The system of claim 26 further comprising means for updating the identification data.

28. The system of claim 27 further comprising means for transmitting the updated identification data to the web server.

29. The system of claim 28 further comprising means for updating the identification data on the second transceiver via the web server.

30. A method of locating encoded transceivers comprising:
providing a handheld mobile device having a transceiver;
providing at least a second transceiver configured to communicate with the mobile device transceiver;
storing encoded identification data on the mobile device;
storing encoded identification data on the second transceiver;
transmitting identification data from at least one of the mobile device transceiver and the second transceiver; and,
receiving identification data from at least one of the mobile device transceiver and the second transceiver.

31. The method of claim 30 wherein the identification data is downloaded from the Internet.

32. The method of claim 30 wherein identification data is transmitted automatically when the mobile device and second transceiver are less than 120 meters apart.

33. The method of claim 32 wherein the identification data is received by at least one of the mobile device and second transceiver and relayed to an administration system via wireless carrier.

34. The method of claim 32 wherein the identification data is received by at least one of the mobile device and second transceiver and relayed to an administration system via the Internet.

35. The method of claim 30 wherein the identification date is received by at least one of the mobile device and second transceiver and relayed to an administration system via wireless carrier.

36. The method of claim 30 wherein the identification data is received by at least one of the mobile device and second transceiver and relayed to an administration system via the Internet.

37. A method for remotely accessing and controlling devices comprising:
providing a handheld mobile device having a transceiver;
providing a second transceiver configured to communicate with the handheld mobile device transceiver;
providing a device, remote from the mobile device and second transceiver, configured to communicate with the second transceiver; and,
providing an application for sending and receiving secure transmissions installed in the handheld mobile device.

38. The method of claim 37 further comprising the mobile communication device communicating with the second transceiver with a Bluetooth communication protocol.

39. The method of claim 38 further comprising amplifying the mobile communication device transceiver and second transceiver to provide a communication range greater than 100 meters.

40. The system of claim 37 further comprising encrypting communication signals between the mobile communication device and second transceiver.

41. The system of claim 37 further comprising configuring the mobile communication device transceiver to send and receive variable code and frequency signals.

42. The system of claim 41 further comprising configuring the second transceiver to send and receive variable code and frequency signals.

43. The system of claim 41 further comprising installing the second transceiver into an automobile.

44. The system of claim 43 wherein the provided device comprises at least one of a vehicle diagnostic information, car door lock operation, door opening operation, window operation, sun roof operation, environmental controls operation, trunk operation, fluid level operation, gas cap operation, hood operation, engine exhaust monitoring operation, air bag status and operation, radio operation, ignition operation and braking operation.

45. The system of claim 44 further comprising providing a plurality of cell phones having transceivers to communicate with the second transceiver.

46. The system of claim 44 further comprising the plurality of cell phones communicating with the second transceiver using a Bluetooth communication protocol.

47. The system of claim 37 wherein the provided device comprises at least one of vehicle diagnostic information, navigation system, car door lock operation, door opening operation, window operation, sun roof operation, environmental controls operation, trunk operation, fluid level operation, gas cap operation, hood operation, engine exhaust monitoring operation, air bag status and operation, radio operation, ignition operation and braking operation.

48. The system of claim 37 further comprising installing the second transceiver in a building.

49. The system of claim 48 wherein the provided device comprises at least one of a building alarm system, building fire system, perimeter access, commercial, residential, auto, door bell, garage door opener, light system, home appliance, stereo system, audio/visual system, video monitoring system, building door lock system, telephone systems, Internet systems, satellite systems, cable systems, cable set top box, game box, heating system, air conditioning system, and HVAC system.

50. The system of claim 49 further comprising hard-wiring the device to the second transceiver.

51. The system of claim 49 further configuring the device to receive RF signals from the second transceiver.

52. The system of claim 51 further comprising providing the device with a transceiver for transmitting and receiving RF signals from the second transceiver.

53. The system of claim 52 wherein the device communicates with the second transceiver using a Bluetooth communication protocol.

54. The system of claim 37 wherein the provided handheld device is a cell phone, personal digital assistant, blackberry device, and portable computer.
